(19) United States
(12) Patent Application Publication
(10) Pub. No.: US 2018/0241582 A1
(43) Pub. Date: Aug. 23, 2018

(54) CONTROL SYSTEM, OPERATION DETERMINING APPARATUS, DEVICE, CONTROL METHOD, AND CONTROL PROGRAM

(71) Applicant: SHARP KABUSHIKI KAISHA, Sakai City, Osaka (JP)

(72) Inventors: HIDEKI NISHIMURA, Sakai City (JP); MASAYUKI NAKAZAWA, Sakai City (JP); SHINGO YAMASHITA, Sakai City (JP); SHUNSUKE YAJIMA, Sakai City (JP)

(21) Appl. No.: 15/752,840

(22) PCT Filed: Sep. 29, 2016
(86) PCT No.: PCT/JP2016/078868

§ 371 Date: Feb. 14, 2018

(30) Foreign Application Priority Data
Oct. 2, 2015 (JP) 2015-197090

(51) Int. Cl. H04L 12/28

(52) U.S. Cl. CPC H04L 12/282; H04L 12/2829; H04L 2012/2849; H04L 2012/285; H04L 12/2832

(57) ABSTRACT

A storage unit (M12) stores correspondence information in which at least two pieces of information among environment information, person information, and the device information detected by at least one of a plurality of devices (U1-n) and external information provided by an external device and autonomous operation information including operation information of the plurality of devices and notification information representing notification using a sound, a light, or an image of the plurality of devices are associated with each other. A control unit (M11) acquires the at least two pieces of information. The control unit (M11) determines the autonomous operation information based on the correspondence information and the at least two pieces of information. An input/output unit (U13-n) executes a notification, which is a notification corresponding to an operation based on the operation information, using a sound, a light, or an image in accordance with the notification information based on the autonomous operation information determined by the control unit (M11).

### TECHNICAL FIELD

Aspects of the present invention relate to a control system, an operation determining apparatus, a device, a control method, and a control program.

Priority is claimed on Japanese Patent Application No. 2015-197090, filed on Oct. 2, 2015, the content of which is incorporated herein by reference.

### BACKGROUND ART

In a device such as an electrical appliance, an LED or a display panel is disposed in order to indicate the operation state and the like of the device.

Meanwhile, in a device such as an electric appliance, transmitting information using sound is known. For example, in Patent Document 1, achieving improvement in user-friendliness by preventing uniform sound output in an electric appliance having a sound output function is described.

In addition, in Patent Document 2, a feelings calculating apparatus is described which calculates feelings data indicating a degree of feeling induced based on a pressure detected by a pressure detecting means, converts the feelings data into at least one of a sound, a light, an image, a video, and a vibration, and outputs a result of the conversion.

### PRIOR ART DOCUMENTS

### Patent Documents

### [Patent Document 1]

Japanese Unexamined Patent Application, First Publication No. 2005-31540

### [Patent Document 2]

Japanese Unexamined Patent Application, First Publication No. 2005-152054

### SUMMARY OF INVENTION

### Problem to be Solved by Invention

However, the technology disclosed in Patent Document 2 merely allows determination of feelings data for the user.

In a device such as an electric appliance or the like, it is preferable to arouse sympathy for a device or the like by causing a user to feel emotion.

Several aspects of the present invention have been realized in consideration of the points described above and provide a control system, an operation determining apparatus, a device, a control method, and a control program capable of causing a user to have an emotion.

### Means for Solving the Problems

(1) Some aspects of the present invention are made to solve the above-described problem, and one aspect of the present invention is a control system including: a storage unit that stores correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other, an information acquiring unit that acquires the at least two pieces of information; a determination unit that determines the autonomous operation information based on the correspondence information and the at least two pieces of information acquired by the information acquiring unit; and an output unit that executes a notification, which is a notification corresponding to an operation based on the operation information, using a sound, a light, or an image in accordance with the notification information based on the autonomous operation information determined by the determination unit.

(2) In addition, one aspect of the present invention is, in the above-described control system, the autonomous operation information further includes identification information of the plurality of devices, wherein the determination unit determines one piece of the identification information of the plurality of devices based on the correspondence information and the at least two pieces of information acquired by the information acquiring unit, and wherein a device represented by the one piece of the identification information of the plurality of devices determined by the determination unit includes the output unit, and the output unit executes the notification.

(3) In addition, one aspect of the present invention is, in the above-described control system, the storage unit stores the at least two pieces of information and the identification information of the plurality of devices in association with each other as the correspondence information, wherein the determination unit determines a plurality of pieces of the identification information of the plurality of devices based on the correspondence information and the at least two pieces of information acquired by the information acquiring unit, and wherein a plurality of devices represented by the plurality of pieces of the identification information of the plurality of devices determined by the determination unit include the output units, and the output units execute different notifications.

(4) In addition, one aspect of the present invention is, in the above-described control system, it further includes: a direction input unit that inputs a direction from a user; and an update unit that updates the correspondence information based on the direction input to the direction input unit after the output unit executes the notification.

(5) In addition, one aspect of the present invention is, in the above-described control system, it further includes: a communication unit that transmits the correspondence information for a target device to the target device executing an operation, wherein the target device includes the determination unit, and wherein the determination unit determines the autonomous operation information based on the correspondence information transmitted by the communication unit and the at least two pieces of information acquired by the information acquiring unit.

(6) In addition, one aspect of the present invention is an operation determining apparatus including: an information acquiring unit that reads correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other from a storage unit and acquires the at least two pieces of information; and a determination unit that determines the autonomous operation information based on the correspondence information and the at least two pieces of information acquired by the information acquiring unit.

(7) In addition, one aspect of the present invention is a device including: an operation unit that exerts a function of its own device; a direction input unit that inputs a direction from a user; a communication unit that receives autonomous operation information, which is autonomous operation information based on environment information, person information, or device information detected by another device, including notification information corresponding to an operation of its own device; and an output unit that executes a notification, which is a notification corresponding to the operation of its own device, using a sound, a light, or an image in accordance with the notification information based on the autonomous operation information.

(8) In addition, one aspect of the present invention is that, in the above-described device, the communication unit transmits environment information, person information, or device information detected by its own device.

(9) In addition, one aspect of the present invention is a control method including: an information acquiring step of reading correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other from a storage unit and acquiring the at least two pieces of information using an information acquiring unit; a determination step of determining the autonomous operation information based on the correspondence information and the at least two pieces of information acquired in the information acquiring step using a determination unit; and an output step of executing a notification, which is a notification corresponding to an operation based on the operation information, using a sound, a light, or an image in accordance with the notification information based on the autonomous operation information determined in the determination step using an output unit.

(10) In addition, one aspect of the present invention is a control program causing a computer of one or a plurality of apparatuses included in a control system to execute: an information acquiring process of reading correspondence information in which at least two pieces of information among environment information, person information, and the device information detected by at least ore of a plurality of devices and external information provided by an external device and autonomous operation information including operation information of the plurality of devices and notification information representing notification using a sound, a light, or an image of the plurality of devices are associated with each other from a storage unit and acquiring the at least two pieces of information; a determination process of determining the autonomous operation information based on the correspondence information and the at least two pieces of information acquired in the information acquiring process; and an output process of executing a notification, which is a notification corresponding to an operation based on the operation information, using a sound, a light, or an image in accordance with the notification information based on the autonomous operation information determined in the determination process using an output unit

### Effect of Invention

According to several aspects of the present invention, sympathy for a device or the like can be aroused by causing a user to feel emotion.

### BRIEF DESCRIPTION OF DRAWINGS

FIG. 1 is a schematic diagram illustrating one example of a control system according to a first embodiment of the present invention.

FIG. 2 is a schematic diagram illustrating the configuration of the control system according to this embodiment

FIG. 3 is a functional block diagram illustrating a schematic configuration of the control system according to this embodiment

FIG. 4 is a schematic diagram illustrating an example of an output of each device according to this embodiment

FIG. 5 is a schematic diagram illustrating an example of an output of each device according to this embodiment

FIG. 6 is a schematic diagram illustrating the operation of the control system according to this embodiment

FIG. 7 is an explanatory diagram illustrating one example of a use case according to a second embodiment of the present invention.

FIG. 8 is a schematic block diagram illustrating the configuration of a device according to this embodiment

FIG. 9 is a schematic block diagram illustrating the configuration of an information processing apparatus according to this embodiment.

FIG. 10 is a schematic block diagram illustrating the configuration of a control apparatus according to this embodiment.

FIG. 11 is a schematic diagram illustrating one example of a sequence correspondence information table according to this embodiment

FIG. 12 is a schematic diagram illustrating one example of a sequence information table according to this embodiment.

FIG. 13 is a schematic diagram illustrating one example of a notification information table according to this embodiment

FIG. 14 is a schematic diagram illustrating one example of a device registration information table according to this embodiment

FIG. 15 is a schematic sequence diagram of the control system according to this embodiment.

FIG. 16 is a schematic diagram illustrating one example of a history information log according to this embodiment

FIG. 17 is a schematic diagram illustrating one example of a sequence information table after update according to this embodiment

FIG. 18 is a functional block diagram illustrating a schematic configuration of a control system according to a third embodiment of the present invention.

FIG. 19 is a functional block diagram illustrating a schematic configuration of a control system according to a fourth embodiment of the present invention.

FIG. 20 is a schematic diagram illustrating one example of a notification information table according to this embodiment

FIG. 21 is a functional block diagram illustrating a schematic configuration of a control system according to a fifth embodiment of the present invention.

FIG. 22 is a functional block diagram illustrating a schematic configuration of a control system according to a sixth embodiment of the present invention.

FIG. 23 is a schematic sequence diagram of the control system according to this embodiment

FIG. 24 is a schematic sequence diagram of the control system according to this embodiment

### EMBODIMENTS FOR CARRYING OUT INVENTION

### First Embodiment

Hereinafter, a first embodiment of the present invention will be described in detail with reference to the drawings.

### <Control System>

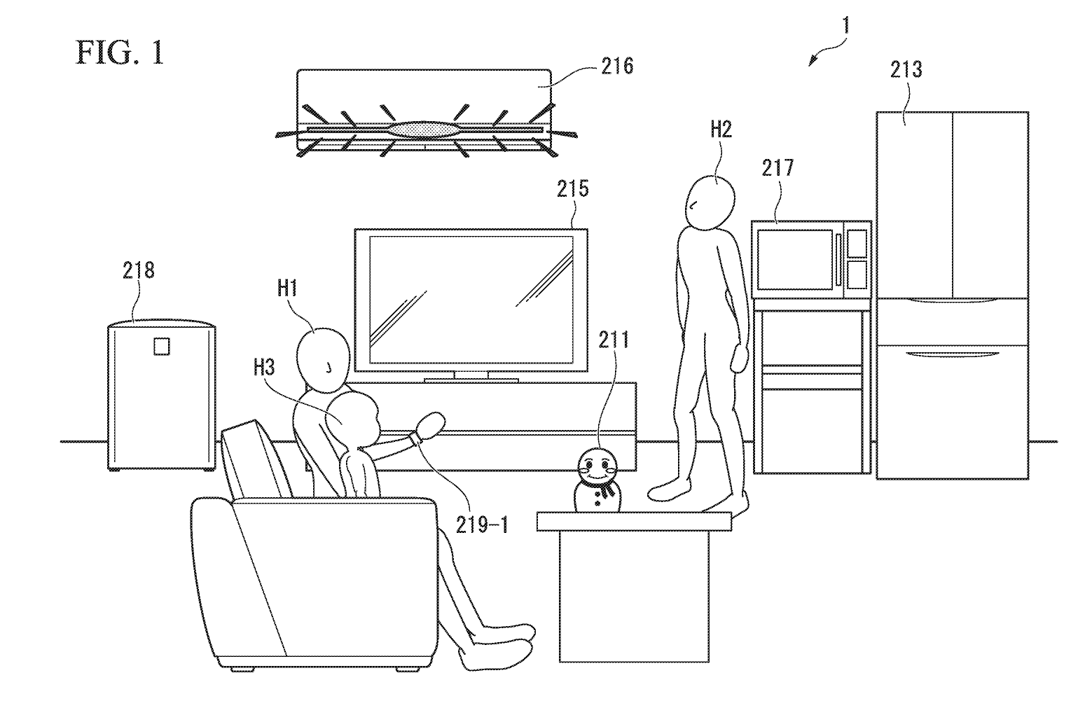

FIG. 1 is a schematic diagram illustrating one example of a control system 1 according to a first embodiment of the present invention. This diagram illustrates a situation in which the control system 1 is used in a certain room in a certain home.

This family has a family configuration of a father H1, a mother H2, and a child H3. Electrical appliances such as a robot 211, a refrigerator 213, a television receiver (television) 215, an air conditioner (air-con) 216, a cooking device 217, and an air purifier 218 are disposed in this room. In addition, wearable devices such as communication devices 219-1, 219-2 (not illustrated in the drawing), and 219-3 (not illustrated in the drawing) are respectively being worn by the father H1, the mother H2, and the child H3.

Furthermore, the father H1 and the mother H2 are holding portable devices such as smartphones as communication devices 260 and 270.

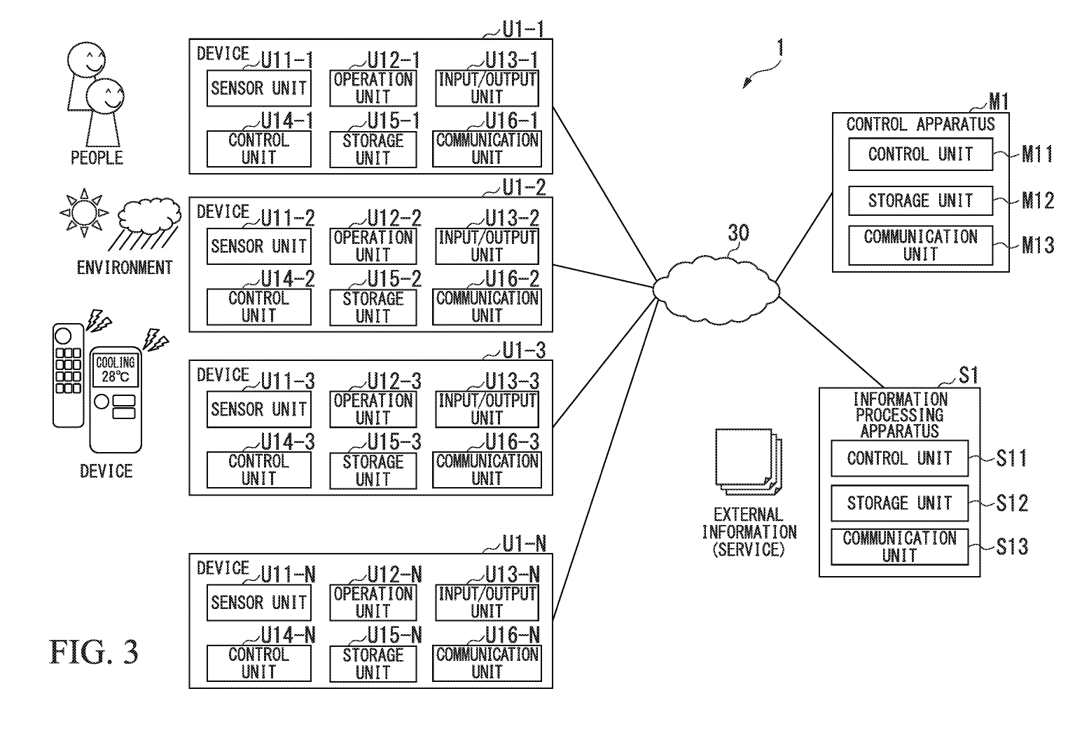

The devices such as the electrical appliances, the wearable devices, and the portable devices are connected to a control apparatus M1 (see FIG. 3) through a network. The control apparatus M1 acquires environment information, device information, and person information from such devices.

Here, the environment information is information detected by a sensor of each device and, for example, is information indicating the environment of the surroundings of the device or the periphery of the sensor. The device information, for example, is information indicating the operation state of each device or the setting of the device. Here, the operation state may be either a current operation state or a future (programmed) operation state. In addition, the device information may be the internal information of a device.

The person information is information indicating a person or the state (including the state of the feelings) of the person.

Meanwhile, the control apparatus M1 may acquire external information from other information processing apparatuses. The external information, for example, may be information of a service provided through a network such as the Internet.

The control apparatus M1 determines an autonomous operation, for example, based on at least two types of information among the environment information, the device information, the person information, and the external information that have been acquired. Here, the autonomous operation, for example, is an operation of each device and is an operation recommended for a person. In addition, the autonomous operation is determined based on at least two types of information. For example, irrespective of whether an operation to be performed later by a device or an operation to be performed currently by a device is selected based on the device information, the autonomous operation can be changed in accordance with the environment information. In other words, since in a case in which an operation is based on one type of information, the operation is limited to an operation directed by a user or an operation that can be understood by a user, by adding one type of information, the control system 1 can propose a more finely-modeled operation. Accordingly, a user feels as if each device autonomously proposing an operation. Similarly, an autonomous operation is changed in accordance with a processing target (for example, a menu and ingredients in the case of a cooking device) and a user of a device.

As examples of autonomous operations, there are operations relating to clothes (washing, drying, and the like), operations relating to foods (cooking, preservation of food ingredients, and the like), operations relating to a dwelling (temperature, humidity, contamination in the air, brightness, odors, and the like), or operations of providing information, and the like. In accordance with an autonomous operation, the control apparatus M1 changes the current state of clothes, food, a dwelling, or information.

The control apparatus M1 selects a device that can perform an autonomous operation. When a determined autonomous operation is performed by one or a plurality of devices that have been selected, the control apparatus M1 transmits a notification information (also referred to as “autonomous notification information”) representing a notification (also referred to as an “autonomous notification”) performed by the device.

Here, the notification information is information representing a notification system or a notification function of a device. For example, the information representing a notification system, for example, is information representing a sound, a light, or an image. The information representing a notification function is a notification position (for example, the position of a speaker, the position of a light emitting device, or the position of a display) or a notification pattern (any one or a combination of a plurality of the color of light, a light emitting position, an image, a tone, and a voice tone). In addition, the notification pattern may be a pattern of a notification concerned with a change over time.

For example, the control apparatus M1 determines a position at which an electrical appliance should exert a function (also referred to as a “function exerting position”) or a position (also referred to as a “function exerting operation position”) at which an operation is to be performed by a user for allowing an electrical appliance to exert a function as autonomous notification information. In addition, a position (also referred to as a “autonomous notification position”) indicated by the autonomous notification information may be a position of a notification function closest to a function exerting position or a function exerting operation position, or a position of a notification function that can direct a function exerting position or a function exerting operation position

Each of one or a plurality of devices selected by the control apparatus M1 causes the notification function of the autonomous notification position to perform notification with a notification pattern (also referred to as a “autonomous notification pattern”) represented by autonomous notification information based on the autonomous notification information. In addition, each of the one or a plurality of devices performs notification during the operation of its own device or before the operation of its own device. Here, “before the operation of its own device,” for example, is a state (standby state) in which the power has not been turned on by a user.

In addition, each of the one or a plurality of devices may perform an autonomous operation based on autonomous operation information representing the autonomous operation. Here, each of the one or a plurality of devices may perform an autonomous operation (recommended operation) in a case in which the autonomous operation is permitted by a user (for example, in a case in which a user says “please” or in a case in which a “recommend operation” button is pressed).

FIG. 1, for example, is a diagram of a case in which the mother H2 returns to the living room after cooking in the kitchen. Here, the cooking device 217, for example, 20 seconds ago, is assumed to have transmitted device information representing the completion of cooking (the completion of the operation) to the control apparatus M1. The communication device 219-2 is assumed to have detected moving of the mother H2 from the kitchen to the living room and the body temperature, the sweating rate, or the pulse of the mother H2 and transmit person information representing this detection information, for example, 10 seconds ago to the control apparatus M1. In addition, one of the electrical appliances (for example, the robot 211 or the air conditioner 216) is assumed to have detected the temperature of the living room and transmitted environment information representing the detected information to the control apparatus M1, for example, five seconds ago.

After the completion of cooking using the cooking device 217, the control apparatus M1 may determine that a time (for example, five minutes) set in advance has elapsed based on the device information and determines that the mother H2 has moved to the living room based on the person information. In this case, in a case in which the body temperature of the mother H2 is higher than a threshold, a case in which the sweating rate is higher than a threshold, or a case in which the pulse is higher than a threshold based on the person information, the control apparatus M1 may determine that die body of the mother H2 is hot and sets an operation of cooling the body of the mother H2 as an autonomous operation.

When the autonomous operation is set, the control apparatus M1 determines whether or not the temperature of the living room is higher than a value set in advance based on the environment information. In a case in which the temperature of the living room is determined to be higher than the value set in advance, the control apparatus M1, for example, selects cooling using the air conditioner having a set temperature lower than the temperature of the living room as one of candidates for an autonomous operation. The control apparatus M1 selects the air conditioner 216 as a device that can direct and execute this autonomous operation. In addition, the control apparatus M1 determines autonomous notification information representing a function exerting position.

In the example illustrated in FIG. 1, the air conditioner 216 emits light to a function exerting position, in other words, a position closest to an air outlet port. In addition, the air conditioner 216 outputs a sound “Thank you for the cooking. I will try to strongly cool your hot body.” In addition, the control apparatus M1 may determine autonomous notification information representing a function exerting operation position located in a remote controller (this will be referred to as a “remote controller”), and, in such a case, the remote controller of the air conditioner 216 may cause a button or the like to emit light based on the function exerting operation position. In a case in which the mother H2 enunciates “Please,” the air conditioner 216 detects the enunciation and the contents thereof and performs a recommended operation, in other words, performing cooling to a set temperature lower than the temperature of the living room.

In addition, for example, in a case in which the output is set to be larger than a threshold so as to quickly lower the temperature of the living room, the air conditioner 216 may change the notification form in a pattern corresponding thereto. For example, the air conditioner 216 may blink in blue as the autonomous notification pattern and, in a case in which an output becomes large, emits red light and changes the light emission in accordance with the output. Here, when the air conditioner 216 changes the luminance, the color tone of light, and the range of light in accordance with the output, these may be realized by changing the amplitude or energy of light or the output (applied voltage or current) to a light emitting device.

As above, in the control system 1, an autonomous operation is determined in consideration of the environment information, the device information, the person information or the external information, and each device can propose the determined autonomous operation to the user. In this way, in a case in which a proposal desired by the user is made, the user feels pleasure, and accordingly, the control system 1 can inspire emotion in the user. In addition, the environment information, the device information, the person information, or the external information is information experienced by the user or information in which the user has interest or is affected by. Since each device proposes an autonomous operation based on such information, the user feels that each device understands him or her when making a proposal. In this way, the user feels pleasure due to the device, and accordingly, the control system 1 can inspire emotion in the user.

In addition, for example, each device changes the notification form in accordance with the output. In this way, for example, the user has an impression that each device makes an effort and feels sympathy for the device, and accordingly, the control system 1 can inspire emotion in the user.

### <Configuration of Control System>

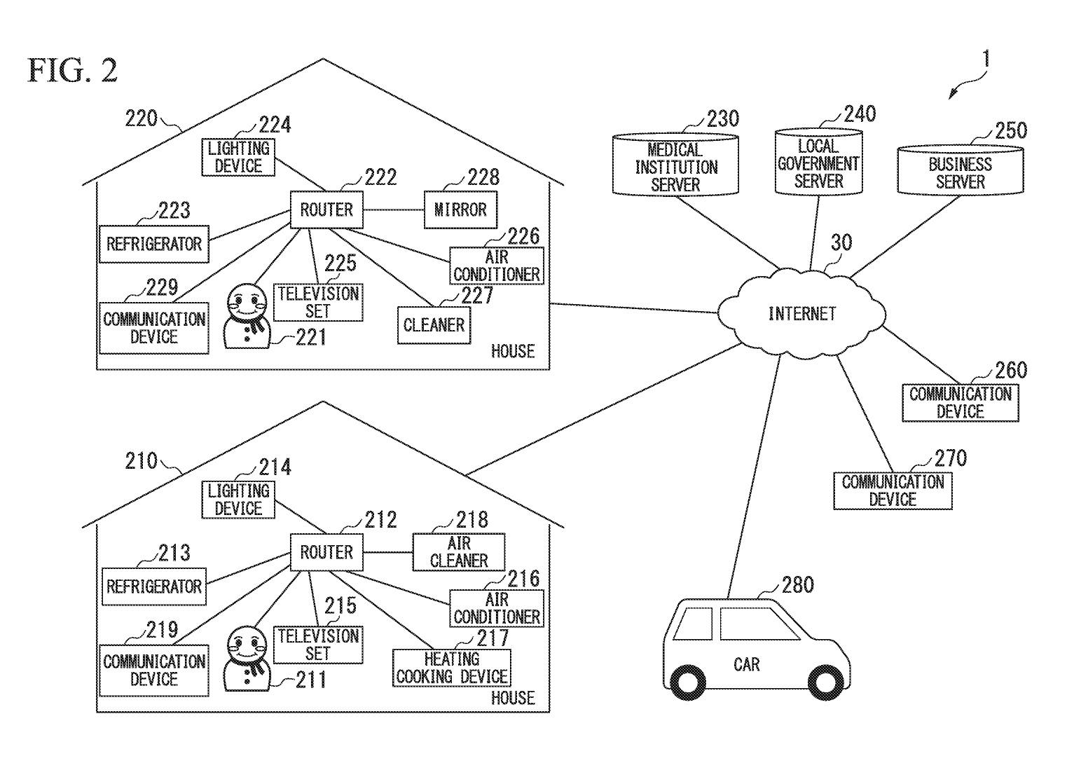

FIG. 2 is a schematic diagram illustrating the configuration of the control system 1 according to this embodiment.

In this drawing, houses 210 and 220, a medical institution server 230, a local government server 240, a business server 250, communication devices 260 and 270, and a car 280 are in a state of being able to communicate through the Internet 30.

Electrical appliances such as a robot 211, a refrigerator 213, a lighting device 214, a television set 215, an air conditioner 216, a cooking device 217, and an air purifier 218 are installed in the house 210. Such electrical appliances and communication devices 219 (the communication devices 219-1, 219-2, and 219-3 described above) are connected to the Internet 30 through a router 212.

In the house 220, electrical appliances such as a robot 221, a refrigerator 223, a lighting device 224, a television set 225, an air conditioner 226, a vacuum cleaner 227, and a smart mirror (mirror) 228 are installed. Such electrical appliances and a communication device 229 are connected to the Internet 30 through a router 222.

The medical institution server 230 is a server of a medical organization and, for example, stores and provides medical information. The medical institution server 230, for example, stores and provides, as medical information, information of a visited medical institutions, the date and time of examinations, examination details (medical conditions), medical examination results (medical conditions and prescribed drugs), and the like for each of pieces of user identification information (national identification number or the like; an “external user ID” to be described later) used for identifying an individual.

The local government server 240 is a server of a local government server, and, for example, stores and provides local government information. The local government server 240, for example, stores and provides, as local government information, each of pieces of information (name, date of birth, sex, address, and the like) of a basic resident register for each of pieces of user identification information (national identification number or the like; an “external user ID” to be described later) used for identifying an individual. In addition, the local government server 240 may store and provide disaster prevention information (evacuation orders and evacuation advice), early warnings (earthquake bulletins and disaster bulletins), events information for local government services, and the like, as local government information.

The business server 250 is a server of an enterprise and, for example, stores and provides enterprise information.

For example, in the case of a telecommunications operator, the business server 250 may store and provide information of membership of organizations such as an SNS and attributes information (sex, age, preferences information, friends information, and the like) of each member as enterprise information. The business server 250, for each piece of user identification information (an “external user ID” to be described later) used for identifying a member, may store and provide information entered on a site, purchase information from a shopping site and the like, tender/bid information from an auction site and the like, search information from a search site and the like, and browsing information from movie site and the like, and the like as enterprise information. In addition, the business server 250 may store and provide news articles and the like, weather information (weather, temperature, humidity, warnings for each region), and the like as enterprise information.

For example, in the case of a car company, for each car (for example, each registration number), a car type, owner information (user identification information (an “external user ID” to be described later)), a name, an address (a telephone number, a mail address, or the like), maintenance information (schedules and histories), recall information, and the like are stored and provided as enterprise information.

In addition, the business server 250 includes a control apparatus M1 (FIG. 3) that controls the control system 1.

The communication devices 260 and 270 are portable devices such as portable phones such as smartphones, basic phones, and feature phones, tablet terminals, or personal computers (PC). The communication devices 260 and 270 may be wearable devices of a wrist-watch type, a wrist band type, a headphone type, or a glasses type,

The car 280 is an apparatus that carries and moves a person, and a car control device is mounted therein. The car control device stores information acquired from an engine control unit (ECU), a car navigation; system, and an air conditioning control apparatus and provides such information as device information, environment information, or person information. For example, the car control device may store and provide position information of a car, history information of destinations, search result information of route searches or movement history information (date and time, passing places passed through, speeds, and the like), the temperature of the inside of or outside the car, and the like for each user (each driver or passenger).

Hereinafter, devices illustrated in FIG. 3 will be described

Each of the devices (an electrical appliance, a communication device, or a car control device) detects environment information. A specific example of the environment information is information representing a temperature, a humidity, pollution in the air (the amount of pollution or a specific material), or the like. In addition, the environment information may be a brightness, an image acquired by capturing the surroundings of the device, a force applied to the device (for example, a load or a vibration), a smell, a sound, a water level, a water quality, or the like. In addition, the environment information may be information representing detection of the presence of a living thing or the number of persons (the number of animals) using infrared light or the like as in the case of a human detection sensor or an animal sensor.

Each device acquires device information. For example, each device may have previously stored therein, for its own device, device identification information (a manufacturing number, a MAC address, or the like) used for identifying the product number, the product name, and the device, information representing functions included in its own device, information representing an installation place of its own device (information representing a room or the like), user identification information representing the owner of its own device, and the capability information of its own device and reads such information. Here, capability information of its own device is information that represents the operation capability, the notification capability, and the like of its own device. Here, the information representing the operation capability of its own device is information representing operations (candidates for autonomous operations) that can be executed by its own device. The information representing the notification capability of its own device is information that represents a notification system or a notification function of its own device.

In addition, each device stores setting information that is currently set in its own device and reads the setting information. Furthermore, in a case in which an operation for its own device is executed, each device stores and reads the operation information (operation details or a result of the operation and settings information that has been set). In addition, each device may detect operation information representing the operation state of its own device using a sensor or the like. In the operation information, for example, internal information (the rotation speed of a member or the temperature of a member), current setting information (an operation mode, a set temperature, or the like), an operation time, and the like are included.

Each device may detect person information. A specific example of the person information is user identification information used for identifying a person specified as a result of authentication. Here, the authentication, for example, is input authentication using an ID, a password, or the like, face authentication, fingerprint authentication, palm shape authentication, vein authentication, voiceprint authentication, or the like. In addition, the person information may include vital data such as a body temperature, a sweating rate, a pulse (heartbeat), or a blood pressure for each user represented by the user identification information. In addition, the person information may include emotion information representing emotion. For example, each device may detect a facial expression, determine that the emotion is good in a case in which a smiling face is detected, and determine that the emotion is bad in a case in which a worried look is detected. In addition, each device may analyze speech and determine an emotion based on a result of the analysis (the kind of speech, a speech speed, a frequency, or the like) or may determine an emotion based on the number of times of speech of the user.

Furthermore, each device may be configured to detect the direction of a face. For example, by including a camera detecting the direction of a face in its own device, each device can determine whether or not a face is directed toward the device and can determine a subject operating a device or a person looking at a certain device.

Each device may be configured to detect the position of a person. By including a human detection sensor in its own device, each device can detect a place at which a person is present and whether or not a person is present near the device and can report information from a device near which a person is present or operate a device near which a person is present, whereby there is an effect that the devices can be used without being wasted. Each device may determine that a person is present near the device in accordance with an operation of the device instead of the person detection sensor

In addition, by using both the authentication of the person information and the detection of the position of a person, each device can determine who a person is and the location of the person.

### <Specific Example of Each Device and Device Information>

Each of the robots 211 and 221, for example, may be a device that is equipped with artificial intelligence and which communicates with a person through speech or facial expressions. Each of the robots 211 and 221 may collect the speech of a person using a microphone and perform speech recognition and language analysis on the speech. Using a result of the language analysis, each of the robots 211 and 221 generates language for a response and converts the generated language into speech and speaks. In addition, each of the robots 211 and 221 can change a facial expression using a result of the language analysis or in accordance with the response.

In addition, the robots 211 and 221 may be realized in corporation with the server by including artificial intelligence, a speech recognition function, a language analysis function, a language generation function, and a robot operation control function in a server such as the control apparatus M1.

In addition, each of the functions of the robot described above may be included in each device inside a house to be described later.

Each of the refrigerators 213 and 223, for example, is an electric refrigerator and is a device that compresses and liquefies refrigerant gas and cools the inside of the refrigerator using the heat of vaporization. Each of the refrigerators 213 and 223 transmits information representing an operation intensity (strong, intermediate, and weak), a set temperature or humidity, a current temperature or humidity of the inside of the refrigerator, food ingredients inside the refrigerator (for example, the kinds or names of the food ingredients) and the like to the control apparatus M1 as device information. For example, each of the refrigerators 213 and 223 transmits information representing user identification information representing a user (in the case of an operation, an operator) and information representing operation details (setting of the operation intensity to “strong” or the like), a time, and the like to the control apparatus M1 as device information for each event (each user operation, an automatic operation (timer operation), or the like) or at a set time.

Each of the lighting devices 214 and 224 is a device that brightly lights the surrounding through emission of light. Each of the lighting devices 214 and 224 transmits information representing on/off of power, the brightness of the lighting device or the lighting intensity (strong, intermediate, or weak), the color of the lighting device, and the like to the control apparatus M1 as device information. For example, each of the lighting devices 214 and 224 transmits user identification information representing a user and information representing operation details (turning on the power and setting the lighting intensity to “strong” and the like), time, and the like to the control apparatus M1 as device information for each event or at a set time.

Each of the television sets 215 and 225 is a device that converts an electric signal delivered in a wireless or wired manner into an image signal as device information and reproduces the image signal as a video. For example, each of the television sets 215 and 225 transmits information representing on/off of the power, a selected broadcast or the type of selected input, a selected channel, brightness, a contrast ratio, and the like to the control apparatus M1 as device information. Each of the television sets 215 and 225 transmits user identification information representing a user and information representing operation details (turning on of the power, a selected channel, and the like), time, and the like to the control apparatus M1 for each event or at a set time as device information.

Each of the air conditioners 216 and 226 is a device that executes air conditioning through cooling, dehumidifying, and heating. Each of the air conditioners 216 and 226 transmits on/off of the power, an operation mode (cooling, heating, dehumidifying, air blowing, or the like) a set temperature or humidity, a wind direction, the amount of wind, an operation intensity, a timer time, or an elapsed time after the start of the operation to the control apparatus M1 as device information. For example, each of the air conditioners 216 and 226 transmits information representing user identification information representing a user and information representing operation details (turning-on of the power, a selected mode, and the like), time, and the like to the control apparatus M1 as device information for each event or at a set time.

The cooking device 217 is a device that heats food ingredients and the like using an oven function, a range function, or the like.

In addition, the cooking device 217 may be a cooking heater using a stove or an induction heating type. The cooking device 217 transmits information representing an operation mode (an electronic range, an oven, defrosting, automatic, or the like), a cooked product (a completed product as a result of the current cooking such as “roast chicken” or a target product such as “chicken” for which cooking is performed), an operation intensity, a set temperature or time, the current temperature of the inside of the device or the temperature of a cooked product (a target project that is currently cooked), operation start time (for example, time at which a start button is pressed), an elapsed time from the operation start time, and the like to the control apparatus M1 as device information. For example, the cooking device 217 transmits information representing user identification information representing a user, operation details (turning on of the power, pressing of a start button, a selected mode, and the like), time, and the like to the control apparatus M1 for each event or at a set time as device information.

The air purifier 218 is a device that is used for cleaning the air by eliminating dusts and floating bacteria in the air and eliminating smells of smoke and the like. The air purifier 218 may have a humidifying function and a dehumidifying function and may have an ion generation function and purify the air using ions. The air purifier 218 transmits information of on/off of the power, an operation mode (air cleaning, humidification, or ion generation), a set humidity, an operation intensity, operation start time (for example, time at which a button is pressed) or an elapsed time after operation start time, and the like to the control apparatus M1 as device information. For example, the air purifier 218 transmits user identification information representing a user and information representing operation details turning-on of the power, a selected mode, and the like), time, and the like to the control apparatus M1 as device information for each event or at a set time.

The vacuum cleaner 227 is a device that removes wastes, dusts, and the like by sucking them. The vacuum cleaner 227 transmits information representing turning on/off of the power, an operation mode (a carpet, flooring, or a mat), a suction intensity, an operation start time or an elapsed time after the operation start time, and the like and position information of its own device to the control apparatus M1 as device information. For example, the vacuum cleaner 227 transmits user identification information representing a user and information representing operation details, time, the position information of its own device, and the like to the control apparatus M1 as device information for each event or at a set time.

The smart mirror 228 is a mirror having a display function and is a device that can execute switching between the display function and a reflection (mirror) function. The smart mirror 228 transmits information representing a displayed image and the like to the control apparatus M1 as device information. In addition, the smart mirror 228 transmits information representing a captured image (an image of a person's facial expression, a thermographic image, or the like) and the like to the control apparatus M1 as person information.

Each of the communication devices 219 and 229 is a wearable device of a wrist watch type, a wrist band type, a headphone type, a glass type, or the like. Each of the communication devices 219 and 229 may be a portable device such as a portable telephone device, a tablet terminal or a PC. Each of the communication devices 219 and 229 mainly detects vital data and transmits the detected data to the control apparatus M1 as person information. Each of the communication devices 219 and 229 transmits information representing the position (a position measured by a GPS or the like), acceleration, the posture of the body, or a direction of its own device to the control apparatus M1 as device information. For example, each of the communication devices 219 and 229 transmits user identification information representing a user and information representing operation details, time, the position information of its own device, and the like to the control apparatus M1 as device information for each event or at a set time.

In addition, the device is not limited to the example described above and, for example, may be an electrical appliance such as a washing/drying machine, a rice cooker, a mixer, an electric fan, a dehumidifier, a humidifier, or a futon dryer.

### <Configuration of Device and Apparatus of Control System>

FIG. 3 is a functional block diagram illustrating a schematic configuration of the control system 1 according to this embodiment

The control system 1 includes N devices U1-n (n=1, 2, . . . N), an information processing apparatus S1, and a control apparatus M1. The robots 211 and 221, die refrigerators 213 and 223, the lighting devices 214 and 224, the television sets 215 and 225, the air conditioners 216 and 226, the cooking device 217, the air purifier 218, the vacuum cleaner 227, the smart mirror 228, the communication devices 219, 229, 260, and 270, and the car control device of the car 280 illustrated in FIG. 2 correspond to the devices U1-n. A part of the medical institution server 230, the local government server 240, the business server 250 illustrated in FIG. 2 corresponds to the information processing apparatus S1. The other part of the business server 250 illustrated in FIG. 2 corresponds to the control apparatus M1.

### <Configuration of Device>

The devices U1-n are configured to respectively include sensor units U11-n, operation units U12-n, input/output units U13-n, control units U14-n, storage units U15-n, and communication units U16-n.

The sensor units U11-n detect information of the inside or the outside of the devices U1-n (the peripheries of the devices).

For example, the environment information, the device information, and the person information of the devices U1-n are detected.

Each of the operation units U12-n executes an operation exerting the function of its own device under the control of the control unit U14.

Each of the input/output units U13-n includes a button and the like as an input unit in a device main body or a remote controller.

The button may be either a physical button or an image button displayed on a touch panel. In addition, each of the input/output units U13-n includes a speaker, a light emitting device, a display, or the like as an output unit in a device main body or a remote controller.

The control units U14-n control units of the devices U1-n based on information input from the input/output units U13-n, information detected by the sensor units U11-n, information stored by the storage units U15-n to be described later, and information received by the communication units U16-n. For example, the control units U14-n respectively operate the operation units U12-n to output information to the input/output units U13-n in accordance with autonomous operation information received by the communication units U16-n. In addition, the autonomous operation information is information used for directing an operation and, for example, includes an operation ID used for operating an operation and notification information (including light emitting information and speech information).

The storage units U15-n respectively store programs, environment information, device information, person information, autonomous operation information, and the like of the devices U1-n. For example, in the device information, as described above, setting information is included, and a history of operation information is also included.

The communication units U16-n transmit and receive information, thereby communicating with external devices. The communication units U16-n, for example, transmit information stored by the storage units U15-n to the control apparatus M1. In addition, the communication units U16-n, for example, receive autonomous operation information from the control apparatus M1.

### <Configuration of Information Processing Apparatus>

The information processing apparatus S1 is configured to include a control unit S11, a storage unit S12, and a communication unit S13.

The control unit S11 acquires external information based on information stored by the storage unit S12 to be described later and information received by the communication unit S13. In addition, in the external information, service information (a recipe of a food or the like), recommended information, user's preference information, a reading history of a web site, a history of purchases at a shopping site, program information of broadcast waves, a viewing history of programs, and the like are included. The control unit S11 stores the acquired external information in the storage unit S12 and transmits the external information to the control apparatus M1.

Here, the control unit S11 reads acquisition destination information representing an acquisition destination (an external server or the like) of external information from the storage unit S12 and acquires the external information from the acquisition destination represented by the acquisition destination information. In addition, the control unit S11 reads user correspondence information in which user identification information (also referred to as a “device user ID”) representing the owner or the user of each device and user identification information (also referred to as an “external user ID”) used by the owner or the user in the external device are associated with each other from the storage unit S12. In a case in which the external information including an external user ID is acquired, the control unit S11 assigns a device user ID corresponding to the external user ID to the external information based on the user correspondence information. The control unit S11 stores the external information including the device user ID in the storage unit S12 and transmits the external information to the control apparatus M1.

The storage unit S12 stores the program, the acquisition destination information, the user correspondence information, the external information, and the like of the information processing apparatus S1.

The communication unit S13 transmits and receives information, thereby communicating with an external device. For example, the communication unit S13 receives external information from an acquisition destination represented by the acquisition destination information. In addition, for example, the communication unit S13 transmits the external information to the control apparatus M1.

### <Configuration of Control Apparatus>

The control apparatus M1 is configured to include a control unit M11, a storage unit M12, and a communication unit M13.

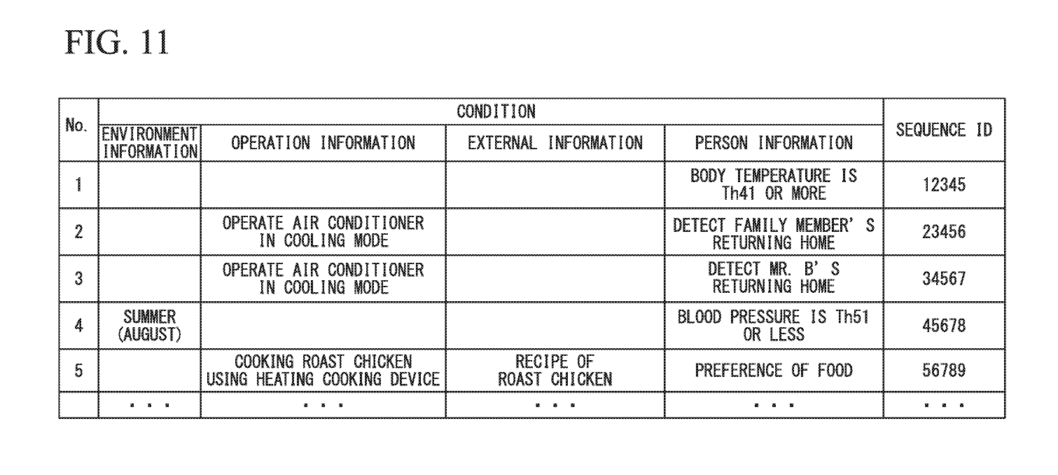

The control unit M11 determines an autonomous operation of each device U1-n and notification information based on information stored by the storage unit M12 to be described later and information received by the communication unit M13. Here, the control unit M11 determines a device U1-n to execute an operation and determine an autonomous operation and notification information of the device U1-n, for example, based on at least two types of information among the environment information, the device information, and the person information acquired from a plurality of devices U1-n and the external information acquired from the information processing apparatus S1. At this time, the control unit M11 reads autonomous correspondence information (see FIGS. 11,12, and 13) in which at least two types of information, the autonomous information, and the notification information are associated with each other from the storage unit M12, determines a device U1-n to execute an operation based on the autonomous correspondence information, and determines an autonomous operation and notification information of the device U1-n.

As one example, the control unit M11 determines an autonomous operation and notification information of the device U1-n based on at least the environment information and the person information. More specifically, the control unit M11 acquires person information representing the body temperature or the sweating rate of the user and environment information representing the temperature of the room from the air conditioner 216. In a case in which the body temperature represented by the person information is higher than a threshold Th11 or in a case in which the sweating rate is higher than a threshold Th12, the control unit M11 determines cooling having a set temperature lower than the temperature of the room or notification of such a proposal. Here, the control unit M11 may determine the intensity of the cooling based on the body temperature or the sweating rate represented by the person information. For example, in a case in which the body temperature represented by the person information is higher than a threshold Th21 (>threshold Th11) and the sweating rate is higher than a threshold Th22 (>threshold Th12), the control unit M11 determines the cooling to be “strong” and sets the set temperature to be lower.

The control unit M11 detects a room in which the user is present, which is represented by the person information, and selects the air conditioner 216 present in the room. The control unit M11 selects notification information of a case in which cooling is recommended for a person feeling warm. This notification information, for example, represents that emission of light using a cool color is executed at a position closest to an air outlet port. In addition, this notification information includes speech information “body will be strongly cooled down for cooling down hot body.”

The control unit M11 transmits the autonomous operation information and the notification information, which represent the determined autonomous operation, to the selected air conditioner 216. He air conditioner 226 pronounces “body will be strongly cooled down for cooling down hot body” based on the received notification information and executes emission of light using a cool color at a position closest to the air outlet port. For example, in a case in which the user pronounces “Please,” the air conditioner 216 executes an autonomous operation represented by the autonomous operation information; in other words, the air conditioner 216 executes cooling having a set temperature lower than the temperature of the room.

As another example, the control unit M11 determines the autonomous operation and the notification information of the device U1-n based on at least the person information and the service information. More specifically, the control unit M11 acquires person information representing a user's smiling face or a user's sigh from the robot 211. In a case in which the number of times of occurrence of a user's smiling face is smaller than a threshold Th31 or in a case in which the number of times of occurrence of a sigh is larger than a threshold Th32, the control unit M11 determines that the user is disappointed. In addition, the control unit M11 may determine the thresholds Th31 and Th32 from an average value of the numbers of times of occurrences of a user's smiling faces or the numbers of times of occurrences of a user's sign.

In a case in which it is determined that the user is disappointed, the control unit M11 acquires the preference information of the user among the external information. The control unit M11 selects a user's favorite program (for example, a program in which a favorite star appears) based on the acquired preference information and determines recommendation of such a music or video. The control unit M11 selects the robot 211 and the television set 215. In addition, the control unit M11 selects notification information of a case in which a video is recommended for the disappointed person. This notification information, for example, represents that emission of light using a warm-color system is executed at a position directing the screen of the television set 215. In addition, this notification information includes speech information “Do you want to watch a program xx? A star Mr. AA appears on the stage.”

The control unit M11 transmits autonomous operation information and notification information, which represent the determined autonomous operation, to the robot 211 and the television set 215 that have been selected. Out of the robot 211 and the television set 215, a device (for example, the robot 211) that detects the user first pronounces “Do you want to each program xx? A star Mr. AA appears on the stage.” based on the received notification information and directs the television set 215 to execute notification using emission of light. The television set 215 emits light in synchronization with the pronunciation of the robot 211 based on the notification information. In addition, in a case in which notification information is transmitted to a plurality of devices, when notification to a specific device (for example, the robot 211) is executed, the control system 1 (the control apparatus M1 or all the devices that have acquired the notification information) may execute control such that the same notification is not executed for the other devices (the television set 215).

In addition, in a case in which it is determined that the user is disappointed, the control unit M11 may notify the user's disappointment to a family member or a friend of the user (hereinafter, referred to as a “family member” or the like). In this case, die control unit M11 may determine notification of information used for encouraging the user to the family member or the like as an autonomous operation. More specifically, the control unit M11 specifies the user and the family member and the like based on the service information. The control unit M11 extracts recollection information of the user and each of the specified family member and the like. The recollection information is a food made by the user and each of the family member and the like altogether, a movie or a program viewed together, a photograph in which the user and each of the family member and the like are shown together, a travel having together, and the like. Here, the control unit M11 may select recollections information representing a recollection of which the experienced date is oldest among the recollections information with priority. In addition, the control unit M11 may store recollections information and emotion information in association with each other and select recollections information associated with a good emotion. More specifically, the information processing apparatus S1 (or the control apparatus M1 or an external apparatus) stores the number of persons having smiling faces and the number of times of occurrence of a smiling face as emotion information in association with the recollections information. The control unit M11 may select emotion information for which the number of persons having smiling faces and the number of times of occurrence of smiling faces are largest and select recollection information corresponding to the selected emotion information with priority.

The control unit M11 selects communication devices 260 and 270 owned by the family member and the like. In addition, for the family member and the like of the disappointed user, the control unit M11 selects notification information of a case in which the user is encouraged. This notification information, for example, represents a display of an image representing a tear or the like (an image of water drops) while light emission of the side faces of the communication devices 260 and 270 is executed. In addition, this notification information includes speech information “Mr. xxx may be disappointed, and so let's encourage Mr. xxx by cooking a Mr. xxx's favorite food or speech information “Mr. xxx may be disappointed, and so let's encourage Mr. xxx by taking a DVD of a movie that was viewed together with Mr. xxx and liked by him.”

The control unit M11 transmits the autonomous operation information and notification information, which represent the determined autonomous operation, to the selected communication devices 260 and 270. The communication devices 260 and 270, based on the received notification information, pronounces speech represented by the speech information while displaying an image representing a tear or the like by light emission of the side face based on the received notification information.

### <Example of Output>

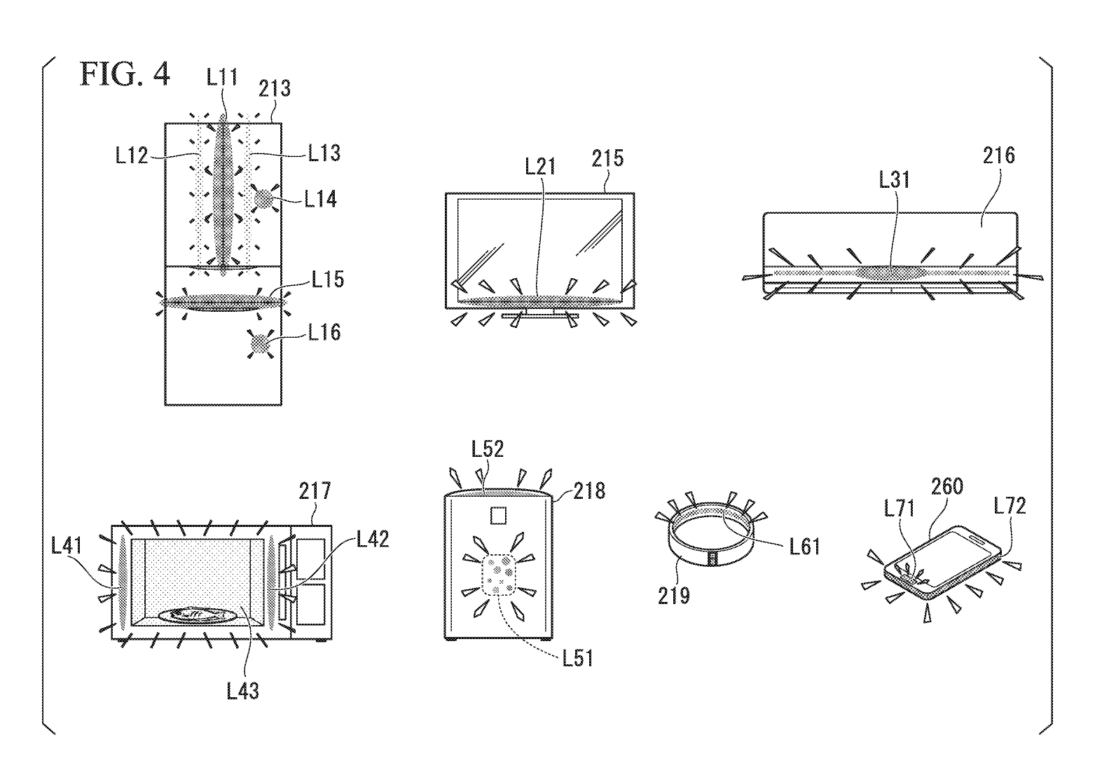

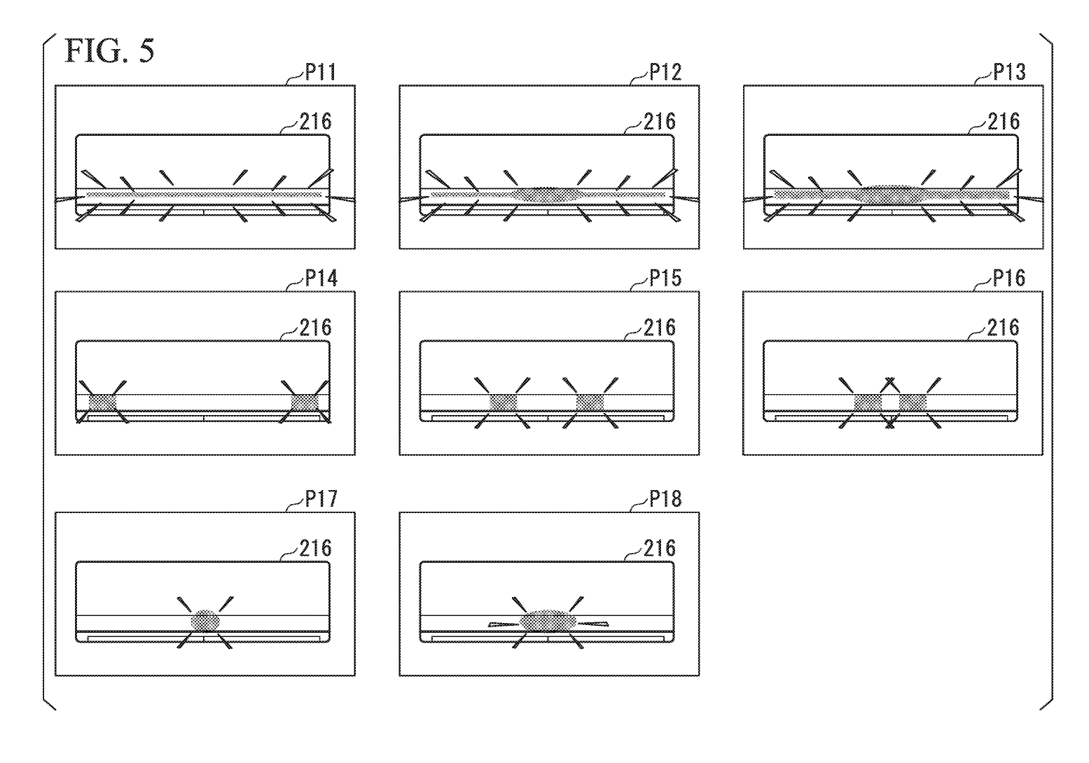

FIGS. 4 and 5 are schematic diagrams illustrating an example of the output of each device U1-n according to this embodiment. This example of the output is an example of light emission of a case in which the input/output units U13-n execute notification.

Each device U1-n executes light emission to create a feeling of vitality, warmth, or ballottement based on the environment information, the device information, the person information, or the external information. It is preferable that the light emission represents the function, the benefit, or the effect of each device U1-n. In addition, it is preferable that the light emission represents a state in which the function, the benefit, or the effect of each device U1-n is exerted. More specifically, light emission is executed near a part of a device (the opening parts of the refrigerators 213 and 223, the peripheries of the screens of the television sets 213 and 223, the air outlet ports of the air conditioners 216 and 226, inside the chamber of the cooking device 217, a part of the air purifier 218 in which an ion generator is mounted or a blowout port thereof, and the like) that brings an effect to the user or a part relating thereto. Accordingly, the user feels like that each device U1-n has consciousness and has an emotion following him, and accordingly, each device U1-n can create an emotional value for the user.

Here, for example, it is preferable that each device U1-n executes light emission not at a point but in a plane or a line.

In addition, in the light emission, spatial or temporal changes in the light emission are preferably gentle. For example, in light emitting devices or pixels adjacent to each other, a difference in the luminance values is within a predetermined value (for example, 10% of the luminance). In addition, in the same light emitting device or in the same pixel, a difference in the luminance value within one second is within a predetermined value (for example, 10% of the luminance). For example, in light emitting devices or pixels adjacent to each other, a difference in the color is within a predetermined value (for example, 10% of each original color). In addition, in the same light emitting device or in the same pixel, a difference in the color within one second is within a predetermined value (for example, 10% of each original color).

Furthermore, each device U1-n preferably changes a lighting place, a lighting color, or a lighting period instead of executing light emission in a fixed color at a fixed place or lighting on off in a fixed period. For example, also in a case in which the devices are operated using the same setting, there may be a difference in a notification pattern (the lighting place, the lighting color, or the lighting period). For example, each device U1-n may change the notification pattern (the lighting place, the lighting color, or the lighting period) in accordance with an operation status (for example, an output or an operation time). More specifically, in a case in which the output is large, or the operation time is long, each device U1-n may set the lighting color to a warm color system and shorten the lighting on/off period. Accordingly, each device U1-n can give the user an impression of each device U1-n desperately operating or an impression of being tired due to a long operation.

In addition, each device U1-n may emit light to display an operation represented by the autonomous operation information. For example, each device U1-n executes light emission displaying the function or the operation at a function exerting position or a function exerting operation position.

### <Light Emission of Refrigerator>

As illustrated in FIG. 4, the refrigerator 213 includes light emitting devices or screens (hereinafter, referred to as “light emitting units”) L11 to L16.

The light emitting unit L11 is arranged in a boundary (opening part) of two doors of the refrigerator 213 at a position facing the doors when the doors are closed. In addition, the light emitting unit L11 may be arranged on a front face or a side face of each door. Here, the light emitting unit L11 is arranged to extend in a direction along the boundary of the two doors. In addition, the light emitting unit L11 may emit light by being triggered upon opening of such two doors. Furthermore, the light emitting unit L11 may change the light emission form (for example, the luminance) in accordance with the opening state of the arranged doors. In addition, the light emitting unit L11 may change the light emission form (for example, the luminance) in accordance with a change in the opening state of the arranged doors. For example, the light emitting unit L11 may strengthen the light emission (increase the luminance) or weakens the light emission in accordance with the degree of opening of the arranged doors. In addition, in a case in which the arranged doors change in a direction in which the arranged doors open, the light emitting unit L11 may strengthen the light emission (increase the luminance) or weaken the light emission in accordance with the change.

The light emitting units L12 and L13 are arranged on the front faces of the doors. For example, each of the light emitting units L12 and L13 is a rectangular screen and has a long side in parallel with one side (a long side in the drawing) of the door. For example, each of the light emitting units L12 and L13 may display a moving image that displays a function exerting operation position. This function exerting operation position is a position representing a handle part of the refrigerator 213 or a contact portion (touch panel) to be in contact by the user for opening the refrigerator 213. The moving image, for example, is an image acquired by aggregating a plurality of pieces of plane light at the function exerting operation position. Here, in a case in which one piece of plane light overlaps another piece of plane light, the light emitting units L12 and L13 may increase the luminance of at least the overlapping portion. Here, plane light is light having an area and, for example, is light acquired by simultaneously emitting lights using a plurality of point light sources or pixels. For example, plane light is light having an area of one square centimeters or more on at least one face of the casing of each device U1-n.

In a case in which a user is allowed to open the doors (in a case in which opening is recommended), the refrigerator 213 displays images on the light emitting units L12 and L13.

The light emitting unit L14 is arranged on the left door. The light emitting unit L14 displays that a desired food ingredient is present at a position represented by the light emitting unit L14 (on the left side (the right side toward the refrigerator) of a middle level of a cold room or the door). In addition, light emitting units similar to the light emitting unit L14 are arranged on the whole face of the door, and the refrigerator 213, in accordance with the position of a desired food ingredient, causes a light emitting unit closest to the position to emit light.

The light emitting unit L15 is arranged in an opening part of a drawer of the lower level. Here, the light emitting unit L15 is arranged in an upper portion of the drawer, in other words, a handle part (or a contact part). In a case in which the user is allowed to open the drawer of the lower level, the refrigerator 213 causes the light emitting unit L15 to emit light.

The light emitting unit L16 is arranged in the drawing of the lower level. The light emitting unit L16 displays that a desired food ingredient is present at a position represented by the light emitting unit L16 (on the leftside (the right side toward the refrigerator) of a refrigeration room). In addition, light emitting units similar to the light emitting unit L16 are arranged on the whole face of the drawer, and the refrigerator 213, in accordance with the position of a desired food ingredient, causes a light emitting unit closest to the position to emit light.

For example, in a case in which a drink is recommended as an autonomous operation, the refrigerator 213 specifies the position of the drink (for example, a middle level of the cold room). In such a case, the refrigerator 213, for example, pronounces “A drink is here” while lighting on/off of the light emitting unit L14. In addition, the refrigerator 213 displays images on the light emitting units L12 and L13 to notify the function exerting operation position. In a case in which the user touches the function exerting operation position, the refrigerator 213 causes the light emitting unit L11 to emit light.

For example, in the case of point light, the light emitting place is limited, and an opening part (or a handle) having a large area (or a large length) cannot be represented. The refrigerator 213 emits light using linear light or plane light along the opening part and thus can represent the opening part. The refrigerator 213, for example, in an opening part (or a handle), can represent the opening part (or the handle) by illuminating a length of 50% (half) of the opening part (or the handle) or more.

### <Light Emission of Television Set>

The television set 215 includes a light emitting unit L21. The light emitting unit L21 is arranged to extend in a horizontal direction in a lower part of the screen (panel) of the television set 215. In addition, in the light emitting unit L21, a light emitting device having high output may be arranged at the center portion, or many light emitting devices may be arranged at the center portion. Accordingly, the light emitting unit L21 causes the center portion to emit light stronger than a peripheral portion.

The light emitting unit L21 represents a screen. In other words, in a case in which an image is recommended to be displayed on the screen, the television set 215 causes the light emitting unit L21 to emit light. Accordingly, the television set 215 represents a function exerting position (screen). For example, in the case of point light, the light emitting place is limited, and a screen having a large area cannot be represented. The television set 215 emits light using linear light or plane light along at least one side (the bottom side of the screen in the example illustrated in FIG. 4) of the screen and thus can represent a screen. The television set 215, for example, in at least one side of the screen, can represent a screen by illuminating a length of 50% (half) of the one side or more.

### <Light Emission of Air Conditioner>

The air conditioner 216 includes a light emitting unit L31. The light emitting unit L31 is arranged to extend in the horizontal direction above the air outlet port of the air conditioner 216. In addition, in the light emitting unit L31, a light emitting device having high output may be arranged at the center portion, or many light emitting devices may be arranged at the center portion. Accordingly, the light emitting unit L31 causes the center portion to emit light stronger than a peripheral portion.

The light emitting unit L31 represents the air outlet port of the air conditioner 216. In other words, in a case in which cooling, warming, dehumidifying, or air blowing is recommended, the air conditioner 216 causes the light emitting unit L31 to emit light. Accordingly, the air conditioner 216 represents a function exerting position (air outlet port). For example, in the case of point light, the light emitting place is limited, and an air outlet port having a large area (or a large length) cannot be represented. The air conditioner 216 emits light using linear light or plane light at least along one side of the air outlet port and thus can represent the air outlet port. The air conditioner 216, in order to represent the air outlet port exerting the effect of air control to be illuminated, for example, in at least one side of the air outlet port, illuminates a length of 50% (half) of the one side or more.

### <Light Emission of Cooking Device>

The cooking device 217 includes light emitting units L41 to L43. The light emitting units L41 and L42 are arranged to extend along sides disposed on the left and right sides of a door of the cooking device 217. The light emitting unit L43 is arranged on the front face of the door of the cooking device 217. In other words, the door of the cooking device 217 is configured as a display device such as a television set. In addition, the light emitting unit L43 may be configured not to include a light source.

For example, the light emitting unit L43 may be configured by a transmission-type liquid crystal panel and display colors and an image using surrounding light.

The light emitting units L41 and L42 represent the inside of the chamber of the cooking device 217. In other words, in a case in which the execution of cooking is recommended, the cooking device 217 causes the light emitting units L41 and L42 to emit light. Accordingly, the cooking device 217 represents a function exerting position (the inside of the chamber). For example, in the case of point light, the light emitting place is limited, and the inside of a chamber having a large area (or a large length) cannot be represented. In addition, in the case of a point light, its own device cannot be appealed without the light being visually distinguished. The cooking device 217 emits light using a linear light or plane light along at least one side of the door and thus can represent the inside of the chamber. The cooking device 217, for example, in at least one side of the door, can represent the inside of the chamber by illuminating a length of 50% (half) of the one side or more.

In addition, in the light emitting unit L43, for example, an image representing fire or a flame is displayed. For example, in a case in which it is recommended to warm or bake a food ingredient or the like or in a case in which a food ingredient or the like is warmed or baked, the cooking device 217 displays an image representing fire or a frame. In addition, fire, a frame, or a heat may be represented using light of a lighting device such as an LED or a change in the light.

### <Light Emission of Air Purifier>

The air purifier 218 includes light emitting units L51 and L52. The light emitting unit L51 is arranged at a center portion of the air purifier 218. The light emitting unit L51 represents a part cleaning the air, in other words, an ion generator. In the case illustrated in FIG. 4, the light emitting unit L51 emits a plurality of pieces of circle-type plane light. These pieces of plane light have different light emission timings and light emission times. In addition, each plane light slowly emits light (gradually strengthen light emission or gradually increasing the light emission area) and suddenly disappears. In other words, each plane light has a short disappearing time interval relative to a completely appearing time interval. For example, the light emitting unit L51 represents an event of a process in which bubbles start to appear on the surface of carbonated water, are gradually enlarged, and are burst open. Accordingly, the air purifier 218 can visually represent a situation in which the air is cleaned. In addition, in the light emitting unit L51, plane light (in the case of an image, a center position of the circle) emitting light may be determined randomly (using a random number).

The light emitting unit L51 represents the ion generator of the air purifier 218. In other words, in a case in which cleaning of the air is recommended, the air purifier 218 causes the light emitting unit L51 to emit light. Accordingly, the air purifier 218 represents a function exerting position (ion generator). For example, in the case of a point light, its own device cannot be appealed without the light being visually distinguished. In addition, although the air and ions are not visually recognized, they are configured by many particles. In the case of point light, may particles cannot be represented. The air purifier 218 emits a plurality of pieces of plane light from a part of the main body and thus can represent an ion generator while representing the cleaning of the air. The air purifier 218, for example, can represent an ion generator by displaying six pieces of plane light or more.

The light emitting unit L52 is arranged to extend along an air outlet port of the air purifier 218.

The light emitting unit L52 represents an air outlet port of the air purifier 218. In other words, in a case in which air cleaning is recommended, the air purifier 218 causes the light emitting unit L52 to emit light. Accordingly, the air purifier 218 represents a function exerting position (air outlet port). For example, in the case of point light, the light emitting place is limited, and an air outlet port having a large area (or a large length) cannot be represented. The air purifier 218 emits light using linear light or plane light at least along one side of the air outlet port and thus can represent the air outlet port. The air purifier 218, in order to represent the air outlet port exerting the effect of air cleaning (cleaned air) to be illuminated, for example, in at least one side of the air outlet port, illuminates a length of 50% (half) of the one side or more.

### <Light Emission of Communication Device>

The communication device 219 includes a light emitting unit L61. The communication device 219 illustrated in FIG. 4 is a wearable device of a wrist band type and is worn by the wrist. The light emitting unit L61 is arranged to extend along one side of the communication device 219. For example, in the case illustrated in FIG. 4, the light emitting unit L61, on the side face of the communication device 219, is arranged in a portion (on the inner diameter side at the time of wearing) close to a wearer (a place in contact with a wearer). In addition, on a face (wearing face; rear face) that is in contact with the wearer, a detection device used for detecting vital data is arranged.

For example, in a case in which the measurement of vital data is recommended, the communication device 219 causes the light emitting unit L61 to emit light. Accordingly, the cooking device 217 represents a function exerting position (detection device). For example, in the case of a point light, its own device cannot be appealed without the light being visually distinguished. The communication device 219 emits light using linear light or plane light at least along one side of the side face and thus can represent the wearing face on which the detection device is arranged. The communication device 219, for example, in at least one side of the rear face or the side face, can represent the wearing face by illuminating a length of 50% (half) of the one side or more.

The communication device 260 includes light emitting units L71 and L72. The communication device 260 illustrated in FIG. 4 is a smartphone. The light emitting unit L71 is arranged in a physical button of the communication device 260 or in the periphery of the physical button. The light emitting unit L72 is arranged on the whole faces of four sides along the side face of the communication device 260.

For example, in the case in which the physical button is desired to be pressed for allowing a user to refer to the screen, the communication device 260 causes the light emitting unit L71 to emit light. For example, in a case in which its own device is desired to be gripped for applying the device to the user, the communication device 260 causes the light emitting unit L72 to emit light. For example, the communication device 260, in at least one side of the side face, can represent the gripping part by illuminating a length of 50% (half) of the one side or more.

In addition, each device U1-n may include a display unit such as a screen in addition to the light emitting unit. In addition, in this display unit, the basic function of each device U1-n or texts and the like relating to the basic function (setting information and the like) are displayed. For example, the television set 215 includes a display unit that displays a video, and the communication device 260 includes a display unit that displays information using an application or the like. For example, the air conditioner 216 includes a display unit that displays settings, a current temperature, and the like, and the cooking device 217 includes a display unit that displays a remaining time and the like.

Here, the basic function of the device U1-n means a specific function that is generally recalled from the product name of the device U1-n. For example, the basic function is a communication function for a portable telephone and is a reproduction and recording function for a DVD reproduction/recording device.

In addition, each device U1-n may include a lamp and the like in addition to the light emitting unit and the display unit described above. This lamp, for example, notifies information (setting information or the like) relating to the basic function of each device U1-n, warning information, and the like.

FIG. 5 illustrates notification patterns P11 to P18 for the light emission of the air conditioner 216. For example, the air conditioner 216 gradually changes from the notification pattern P11 to the notification pattern P12 (for example, over one second) and thereafter gradually changes the notification pattern to the notification pattern P13. Accordingly, the air conditioner 216 represents an air outlet port. In addition, after the notification pattern P13, the air conditioner 216 may gradually change the notification pattern to the notification pattern P12 and thereafter, may gradually change the notification pattern to the notification pattern P11. The air conditioner 216 may repeat the changes of the patterns (P11=>P12=>P13=>P12=>P11) described above for the number of times determined in advance.

Similarly, for example, the air conditioner 216 gradually changes from the notification pattern P14 to the notification pattern P15 and thereafter gradually changes the notification pattern to the notification pattern P16. Thereafter, the air conditioner 216 gradually changes from the notification pattern P16 to the notification pattern P17 and thereafter gradually changes the notification pattern to the notification pattern P18. In other words, in the air conditioner 216, two pieces of plane light become close to each other and intersect at the center portion of the air conditioner 216 to be integrated as one unit. In addition, in the notification patterns P14 to P18, the luminance may be adjusted such that the luminance of the plane light per unit area is constant. For example, regarding the notification pattern P17 and the notification pattern P18, the area of the plane light is smaller in the notification pattern P17, and thus, the air conditioner 216 sets the luminance of the plane light of the notification pattern P17 to be higher than the luminance of the plane light of the notification pattern P18.

In addition, the light emitting units L12 and L13 of the refrigerator 213 may execute notification (rotated by 90 degrees) similar to the notification patterns P14 to P18 illustrated in FIG. 5. In such a case, in the refrigerator 213, as described above, two pieces of plane lights may be configured to intersect with each other at a position (closest position) representing the handle part or the contact part of the refrigerator 213.

### <Summary>

As above, in the control system 1, the storage unit M12 stores correspondence information (FIGS. 11, 12, and 13) in which at least two pieces of information among the environment information, the person information, and the device information detected by each device U1-n and the external information provided by the external device and the autonomous operation information including the operation information (operation ID) of the device and the notification information representing notification using a sound, a light, or an image of the device are associated with each other. The control unit M11 acquires at least two pieces of information among the environment information, the person information, the device information, and the external information. The control unit M11 determines autonomous operation information on the basis the correspondence information and the at least two pieces of information that have been acquired. The input/output unit U13-n executes a notification using a sound, a light or an image corresponding to an operation based on the operation information in accordance with the notification information based on the autonomous operation information determined by the control unit M11.

Accordingly, in the control system 1, a person and the device U1-n can sympathize with each other.

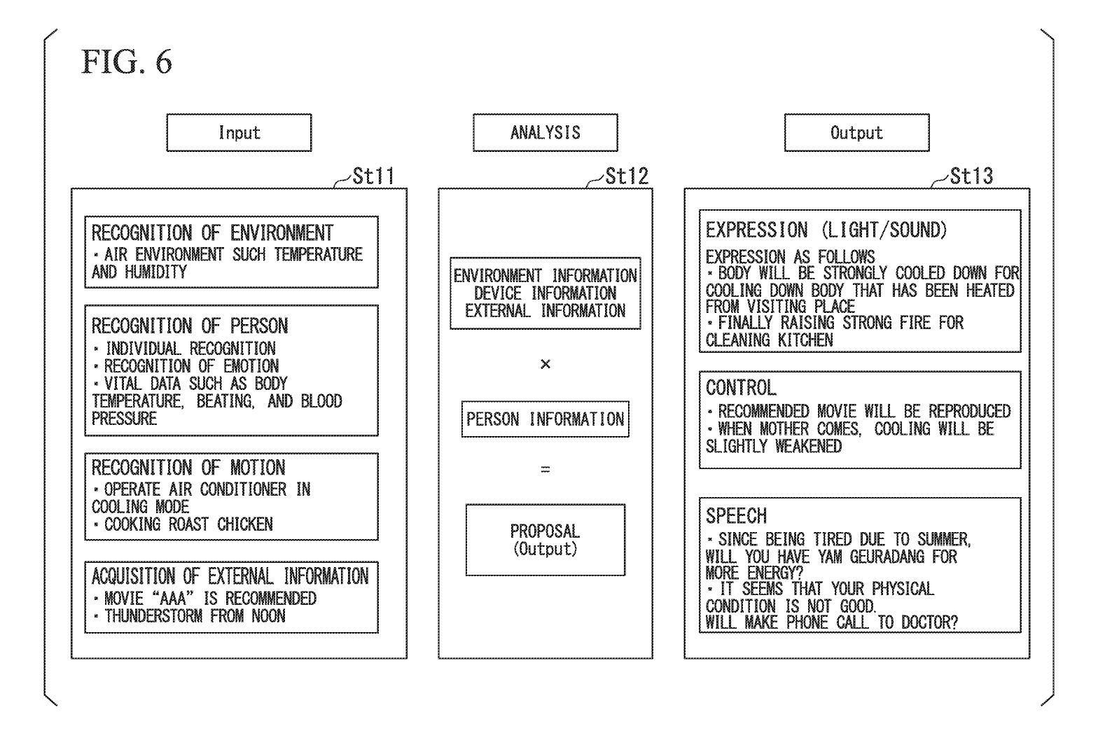

FIG. 6 is a schematic diagram illustrating the operation of the control system 1 according to this embodiment. In the drawing, Steps St11, St12, and S13 respectively represents input, analysis, and output

(Step St11) The control system 1 recognizes environments, a person, and the operation of a device respectively based on the environment information, the person information, and the device information. Alternatively, the control system 1 acquires the external information. Thereafter the process proceeds to Step St12.

(Step St12) The control system 1 determines autonomous operation information (proposal details) based on the environment information, the person information, and the device information or the external information. Theater, the process proceeds to Step St13.

(Step St13) The control system 1 executes an operation (the control of each device U1-n) and notification based on the autonomous operation information. Here, in the notification, light, a sound (also referred to as a “facial expression”; an image is included in the “facial expression,” and a video is also included in the image), and speech are included.

### Second Embodiment

Hereinafter, a second embodiment of the present invention will be described in detail with reference to the drawings. In the second embodiment, one example of a use case of the control system 1 according to the first embodiment will be described. In addition, in the second embodiment, the control apparatus M1, for a plurality of devices U1-n, manages such operations as sequence information and generates autonomous operation information and notification information.

### <One Example of Use Case>

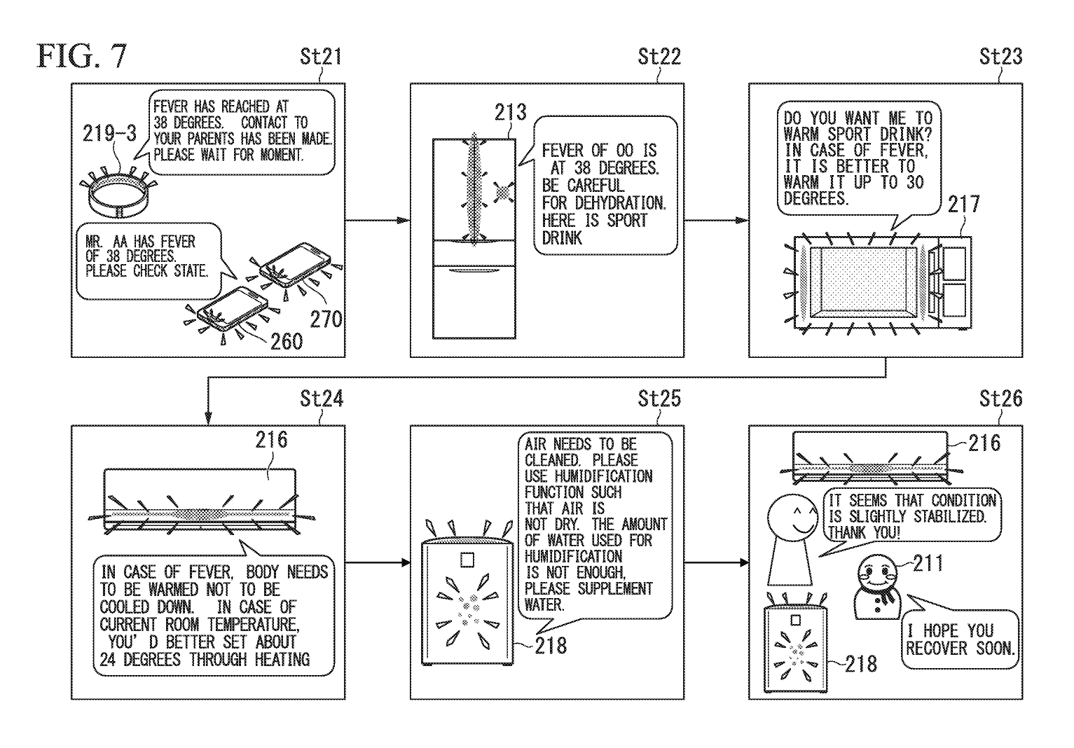

FIG. 7 is an explanatory diagram illustrating one example of a use case according to the second embodiment of the present invention. This diagram is for a case in which a child H3 has a fever due to an illness or the like. In this case, each device U1-n executes the next operation.

(Step St21) A communication device 219-3 attached to the body of the child H3 detects a body temperature higher than a threshold Th41 as the body temperature of the user (child H3). In this case, a communication device 260 owned by the father H1 and a communication device 270 owned by the mother H2 respectively light on the light emitting units L71 and L72 illustrated in FIG. 4 and notifies that the child H3 has a fever using sounds. For example, the communication device 260 and the communication device 270 pronounce that “MR. AA HAS FEVER OF 38 DEGREES. PLEASE CHECK STATE” Thereafter, the communication device 219-3 lights on the light emitting unit L61 illustrated in FIG. 4 and notifies of an indication representing that the child H3 has a fever, an indication that the father H1 and the mother H2 have been contacted, and an indication for encouraging the child H3 by using a sound. For example, the communication device 219-3 pronounces that “THERE IS FEVER OF 38 DEGREES. FATHER AND MOTHER HAVE BEEN CONTACTED.” Thereafter, the process proceeds to Step St22.

(Step St22) In a case in which it is detected that a family member of the child H3 (for example, the mother H2) is present near its own device, the refrigerator 213 lights on the light emitting units L11 and L14 among the light emitting units illustrated in FIG. 4 and notifies of an indication representing that the child H3 has a fever and a proposal of a case in which a person has a fever. For example, the refrigerator 213 pronounces “MR. AA HAS FEVER OF 38 DEGREES. BE CAREFUL FOR DEHYDRATION. HERE IS SPORT DRINK.” Here, the proposal notified from each device U1-n is a proposal for a situation in which a user or the like is placed and is a proposal using an autonomous operation of its own device U1-n. For example, the refrigerator 213 gives a proposal for preventing dehydration of the fever of the child H3. Here, the refrigerator 213 indicates an operation (opening a door) that is necessary for taking out a sport drink using light emission of the light emitting unit L11 while indicating a place of the sport drink inside its own device using light emission of the light emitting unit L14. Thereafter, the process proceeds to Step St23.

(Step St23) In a case in which the refrigerator 213 detects the opening of the door of its own device, the cooking device 217 notifies of a proposal for a case in which a person has a fever and a proposal relating to (continued from) the proposal of the refrigerator 213. This proposal is acquired by adding a proposal using an autonomous operation of the cooking device 217 to the proposal to the refrigerator 213. For example, the refrigerator 213 pronounces “DO YOU WANT ME TO WARM SPORT DRINK? IN CASE OF FEVER, IT IS BETTER TO WARM IT UP TO 30 DEGREES.” In other words, as a proposal for preventing dehydration, the refrigerator 213 and the cooking device 217 propose that a warm sport drink be drunk by the child H3. Thereafter, the process proceeds to Step St24.

(Step St24) In a case in which the child H3 and a family member (for example, the mother H2) of the child H3 are detected to be present in a room in which the air conditioner 216 is installed, the air conditioner 216 lights on the light emitting unit L31 among the light emitting units illustrated in FIG. 4 and notifies of a proposal of a case of a fever of a person. For example, the air conditioner 216 pronounces “IN CASE OF FEVER, BODY NEEDS TO BE WARMED NOT TO BE COOLED DOWN. IN CASE OF CURRENT ROOM TEMPERATURE, YOU'D BETTER SET ABOUT 24 DEGREES THROUGH HEATING.” Here, the air conditioner 216 gives a proposal for a virus and coldness for the fever of the child H3. In addition, the air conditioner 216 indicates the start of blowing a warm wind using light emission of a warm color system while indicating a place (air outlet port) from which wind blowing is started using light emission of the light emitting unit L31. In addition, the air conditioner 216 detects the current temperature of the room and proposes an operation mode and a set temperature based on the detected temperature. Thereafter, the process proceeds to Step St25.

(Step St25) The air purifier 218 that is present in the same room as that of the air conditioner 216 lights on/off of the light emitting unit L51 illustrated in FIG. 4 and notifies a proposal that is a proposal of a case in which a person has a fever and is a proposal of a case in which the air conditioner present in the same room executes heating using a sound. For example, the air purifier 218 pronounces “AIR NEEDS TO BE CLEANED. PLEASE USE HUMIDIFICATION FUNCTION SUCH THAT AIR IS NOT DRY THE AMOUNT OF WATER USED FOR HUMIDIFICATION IS NOT ENOUGH, PLEASE SUPPLEMENT WATER.” Here, the air purifier 218 gives a proposal for a virus or cold air for the fever of the child H3 (clearing of the air using the air cleaning function of its own device and humidification using a humidifying function). In addition, when the humidifying function is proposed, the air purifier 218 detects the amount of water that is necessary for the humidification and, for example, in a case in which the amount of water is not enough, adds the supplement of water. In addition, while a place at which ions are generated is indicated using light emission of the light emitting unit L31, the cleaning of the air is indicated using the light emission. Thereafter, the process proceeds to Step St26.

(Step St26) The family member (for example, the mother H2) of the child H3 ends a countermeasure of a case in which a person has a fever in accordance with the proposal of each device U1-n and checks that the symptom of the child H3 is stabilized. After the checking, the family member of the child H3 gives an expression of gratitude to the robot 211. When the expression of gratitude is detected, the robot 211 checks whether or not autonomous operation information or notification information has been transmitted by each device U1-n. In a case in which it is determined that the autonomous operation information or the notification information has been transmitted within a time set in advance, the robot 211 responses to the expression of gratitude. For example, the robot 211 pronounces that “I HOPE HE RECOVER SOON.” At this time, the robot 211 and each device U1-n emit light for encouraging the family member of the child H3. In addition, when the expression of gratitude is detected, the robot 211 may check whether or not an operation according to the autonomous operation information or the notification information has been executed by each device U1-n. In such a case, when it is determined that an operation according to the autonomous operation information or the notification information has been executed within a time set in advance, the robot 211 responses to the expression of gratitude.

### <Configuration of Device>

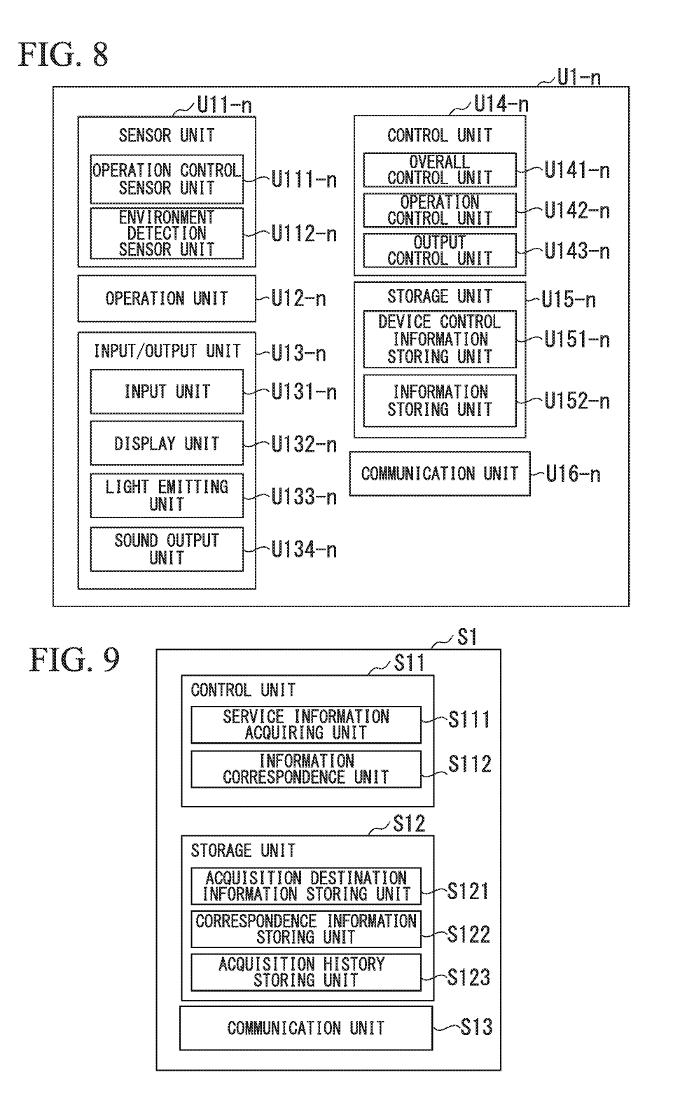

FIG. 8 is a schematic block diagram illustrating the configuration of the device U1-n according to this embodiment. As illustrated in FIG. 3, the device U1-n is configured to include a sensor unit U11-n, an operation unit U12-n, an input/output unit U13-n, a control unit U14-n, a storage unit U15-n, and a communication unit U16-n.

The sensor unit U11-n is configured to include an operation control sensor unit U111-n and an environment detection sensor unit U112-n.

The operation control sensor unit U111-n detects information used in a case in which the basic function of the device U1-n is exerted and information used in a case in which the basic function is being exerted (also referred to as “operation control information”).

The environment detection sensor unit U112-n defects information such as information of the periphery of the device other than the operation control information.

For example, the operation control sensor unit U111-n or the environment detection sensor unit U112 (the sensor unit U11-n) detects a physical quantity or a feature amount such as a temperature, humidity, a particle, the amount of water (the level of water), pressure, a smell, a sound, a light, heat, a position, an acceleration, a distance, an azimuth, time, a time interval, alcohol, a gas, a radiation ray, an angle, magnetism, a person, an animal, a face, a fingerprint, or a vein. In this way, the sensor unit U11-n detects the environment information, the device information, and the person information. In addition, by executing authentication or the like of a user based on the detected information, the sensor unit U11-n may specify a device user ID of the user and set the device user ID as the person information. Furthermore, based on blood relationship information stored in advance, the sensor unit U11-n may specify a family to which a user having a specified device user ID (or not belonging to a family) or a relationship belongs. The sensor unit U11-n may set information representing a specified family or a specified relationship in association with the device user ID as person information.

The operation unit U12-n executes an operation exerting the function of its own device under the control of the control unit U14.

The input/output unit U13-n is configured to include an input unit U131-n, a display unit U132-n, a light emitting unit U132-n, and a sound output unit U133-n.

The input unit U131-n is a button or the like. The input unit U131-n may be included in a device main body or a remote controller.

The display unit U132-n is a display or the like. The display unit U132-n displays texts and the like relating to the basic function of each device U1-n under the control of the control unit U14. In addition, the display unit U132-n may not be included depending on each device U1-n.

The light emitting unit U132-n is a light emitting device such as an LED or a screen such as a liquid crystal panel. The light emitting unit U132-n emits light under the control of the control unit U14. In addition, the light emitting unit U132-n emits light based on the notification information. For example, the light emitting unit U132-n indicates the operation of each device U1-n using a light emitting form (the position and the shape of the light emission, a pattern, a color, luminance, lighting on/off timings, a lighting on off time, and the like). For example, the light emitting unit U132-n may not display texts.

The sound output unit U133-n is a speaker or the like. The sound output unit U133-n outputs a sound. The sound output unit U133-n emits light under the control of the control unit U14. In addition, the light emitting unit U132-n emits light based on the notification information. Here, the notification information is not limited to speech but may be a melody, a sound effect, or a musical piece.

The control unit U14-n is configured to include an overall control unit U141-n, an operation control unit U142-n, and an output control unit U143-n.

The overall control unit U141-n executes overall control of the control unit U14-n and each device U1-n.

The overall control unit U141-n controls each unit of the device U1-n based on information input from the input/output unit U13-n, information detected by the sensor unit U11-n, information stored by the storage unit U15-n, and information received by the communication unit U16-n. In addition, the overall control unit U141-n executes control of transmitting the information input from the input/output unit U13-n, the information detected by the sensor unit U11-n, and the information stored by the storage unit U15-n to the control apparatus M1 through the communication unit U16-n.

The operation control unit U142-n controls the operation of the device U1-n based on the information input from the input/output unit U13-n, the information detected by the sensor unit U11-n (for example, the operation control sensor unit U111-n), the information stored by the storage unit U15-n, and the information received by the communication unit U16-n. For example, in a case in which the autonomous operation information received by the communication unit U16-n includes the device identification information of its own device U1-n, the operation control unit U142-n controls the operation of the operation unit U12-n in accordance with the autonomous operation information.

The output control unit U143-n controls the output based on the information input from the input/output unit U13-n, the information detected by the sensor unit U11-n, the information stored by the storage unit U15-n, and the information received by the communication unit U16-n. For example, the output control unit U143-n controls the light emitting unit U133-n or the sound output unit U133-n in accordance with the notification information received by the communication unit U16-n.

The storage unit U15-n is configured to include the device control information storing unit U151-n and the information storing unit U152-n.

The device control information storing unit U151-n stores a program of the device U1-n. In addition, the device control information storing unit U151-n stores operation control information representing operation control of the device U1-n for each operation ID and stores notification control information representing notification control for each notification pattern.

The information storing unit U152-n stores the environment information, the device information (including a history of operation information), the person information, the autonomous operation information, and the like. For example, in the device information, as described above, for its own device U1-n, device identification information (a manufacturing number, a MAC address, and the like) used for identifying a product number, a product name, and a device, information representing functions included in its own device, information representing the installation place of its own device U1-n (information representing a room or the like), user identification information representing the owner of its own device U1-n, and capability information, setting information, and histories of operation information of its own device U1-n are included.

The communication unit U16-n transmits and receives information, thereby communicating with external devices. The communication unit U16-n, for example, transmits information acquired by assigning the device identification information to the information stored by the storage unit U15-n to the control apparatus M1. In addition, the communication unit U16-n, for example, receives the autonomous operation information including the device identification information of its own device U1-n from the control apparatus M1.

### <Configuration of Information Processing Apparatus>

FIG. 9 is a schematic block diagram illustrating the configuration of the information processing apparatus S1 according to this embodiment. As illustrated in FIG. 3, the information processing apparatus S1 is configured to include a control unit S11, a storage unit S12, and a communication unit S13.

The control unit S11 is configured to include a service information acquiring unit S111 and an information correspondence unit S112. The service information acquiring unit S111 reads acquisition destination information representing an acquisition destination of external information (an external server or the like) from an acquisition destination information storing unit S121 to be described later and acquires external information from the acquisition destination represented by the acquisition destination information.

In a case in which the service information acquiring unit S111 acquires external information including the external user ID, the information correspondence unit S112 reads user correspondence information from the correspondence information staring unit S122. In this case, the information correspondence unit S112 assigns a device user ID corresponding to the external user ED to the external information based on the user correspondence information. The control unit S11 stores the external information including the device user ID in the acquisition history storing unit S123 and transmits the external information to the control apparatus M1.

Here, the external user ID may be different for each service. In other words, in the user correspondence information, a plurality of external user IDs and device user IDs are associated with each other.

In a case in which the service information acquiring unit S111 acquires the external information not including the external user ID, the control unit S11 stores the external information acquired by the service information acquiring unit S111 in the acquisition history storing unit S123 and transmits the external information to the control apparatus M1 through the communication unit S13.

The storage unit S12 is configured to include an acquisition destination information storing unit S121, a correspondence information storing unit S122, and an acquisition history storing unit S123.

The acquisition destination information storing unit S121 stores the acquisition destination information.

The correspondence information storing unit S122 stores the user correspondence information.

The acquisition history storing unit S123 stores the external information, the acquisition date and time, the acquisition destination, the external user ID, the device user ID, and the like acquired by the service information acquiring unit S111.

The communication unit S13 transmits and receives information, thereby communicating with external devices. The communication unit S13, for example, receives the external information from an acquisition destination represented by the acquisition destination information. In addition, the communication unit S13, for example, transmits the external information to the control apparatus M1.

### <Configuration of Control Apparatus>

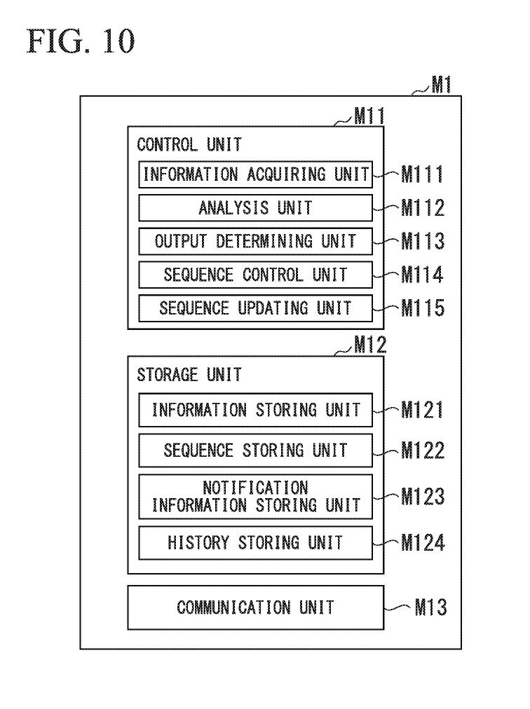

FIG. 10 is a schematic block diagram illustrating the configuration of the control apparatus M1 according to this embodiment. As illustrated in FIG. 3, the control apparatus M1 is configured to include a control unit M11, a storage unit M12, and a communication unit M13.

The control unit M11 is configured to include an information acquiring unit M111, an analysis unit M112, an output determining unit M113, a sequence control unit M114, and a sequence updating unit M115.

The information acquiring unit M111 acquires the environment information, the device information, or the person information from a plurality of the devices U1-n and acquires the external information from the information processing apparatus S1. The information acquiring unit M111 stores the environment information, the device information, the person information, and the external information that have been acquired, in the information storing unit M121.

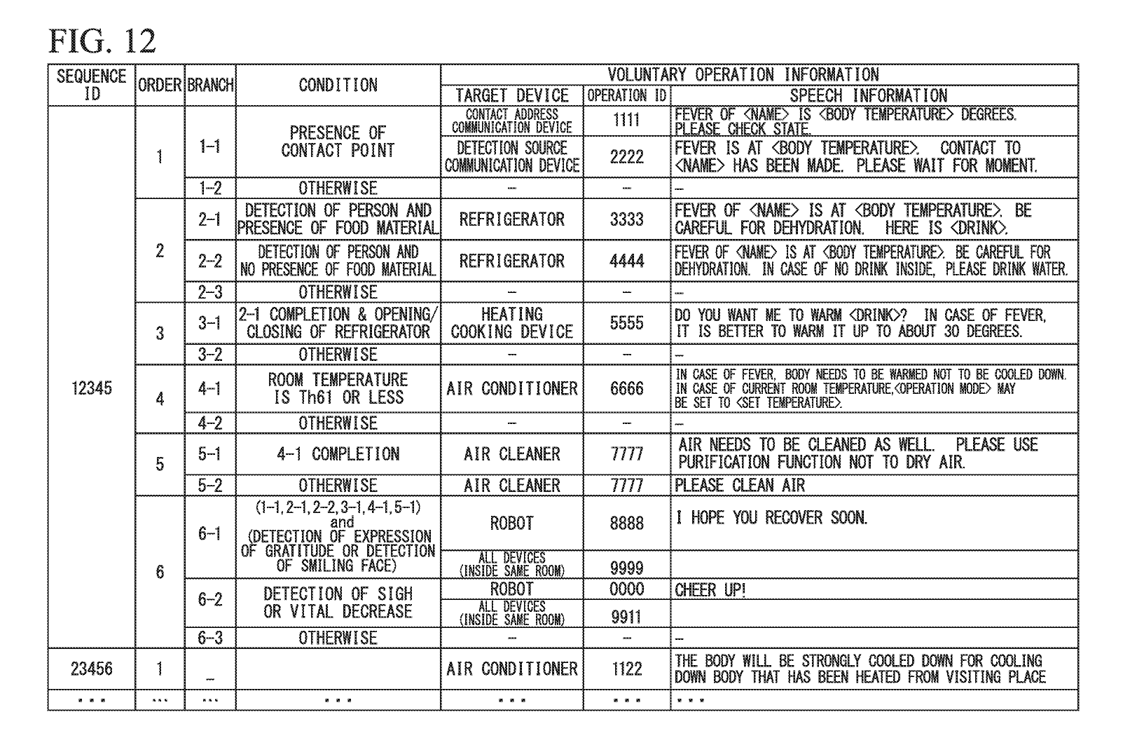

The analysis unit M112 analyzes the information acquired by the information acquiring unit M111. More specifically, the analysis unit M112 determines a device U1-n executing an operation (hereinafter, also referred to as a “target device U1-n”) based on sequence correspondence information stored by the sequence storing unit M122 from a combination among the environment information, the device information, the person information, and the external information and determines an autonomous operation of the determined device U1-n. Here, the sequence correspondence information is information in which the environment information, the device information, the person information, or the external information and a sequence ID used for identifying the sequence are associated with each other (see FIG. 11). The sequence ID is associated with the target device U1-n and an operation ID (autonomous operation) representing the operation. In other words, by determining a sequence ID from a combination among the environment information, the device information, the person information, and the external information, the analysis unit M112 determines a target device U1-n and an autonomous operation. In addition, the analysis unit M112 may determine a plurality of autonomous operations, and, in such a case, a combination (sequence) of a plurality of autonomous operations including order may be determined (see FIG. 12). In addition, the analysis unit M112 may determine a plurality of target devices U1-n.

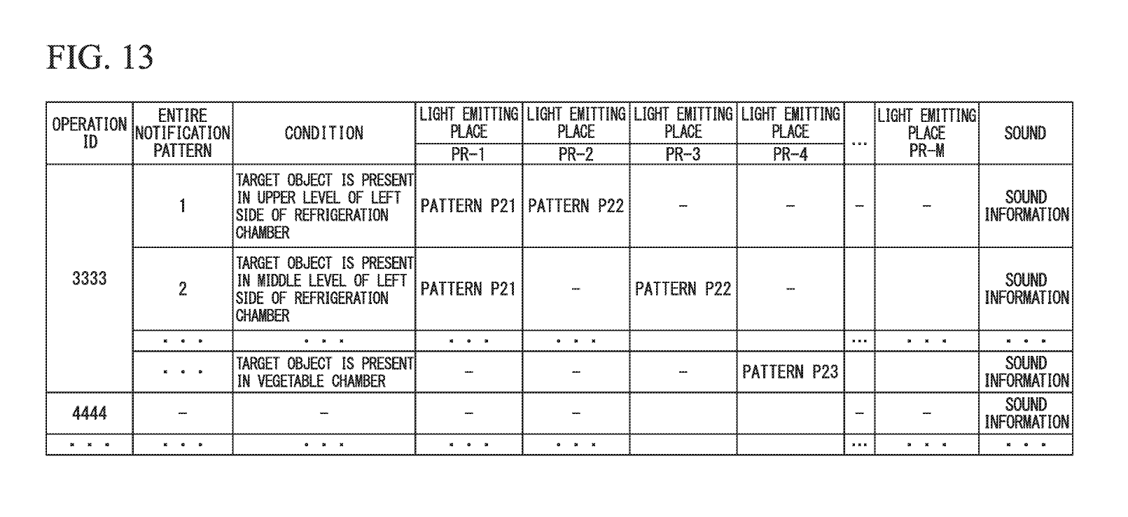

The output determining unit M113 determines notification information based on the information acquired by the information acquiring unit M111. More specifically, the output determining unit M113 determines a device U1-n executing notification based on the sequence correspondence information stored by the sequence storing unit M122 from a combination among the environment information, the device information, the person information, and the external information and determines notification information of the determined device U1-n. Here, in this embodiment, although a case in which the device U1-n executing an operation and the device U1-n executing notification are the same is described, the present invention is not limited thereto, and the devices may be different from each other. In addition, in this embodiment, for a sequence ID, a device U1-n and an autonomous operation (operation ID) of the device U1-n may be associated with each other (see FIG. 12), and an operation ID and notification information may be associated with each other (see FIG. 13). In other words, by determining a sequence ID from a combination among the environment information, the device information, the person information, and the external information, the output determining unit M113 determines a device U1-n executing notification and notification information.

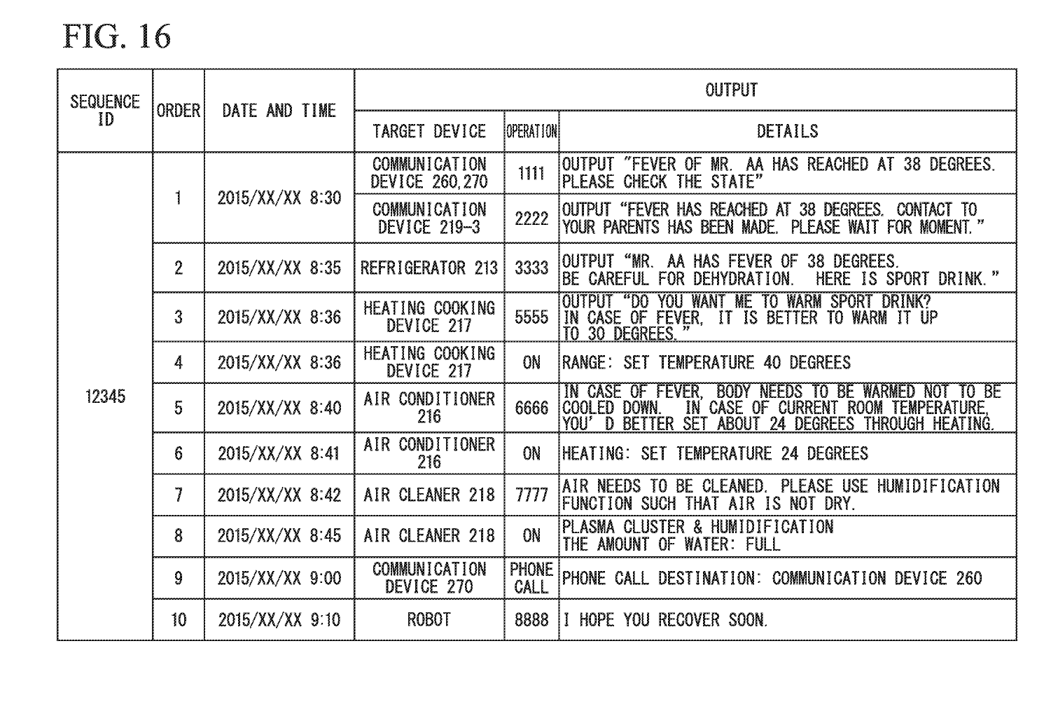

The sequence control unit M114 executes control of each device U1-n to acquire a sequence ID determined by the analysis unit M112 and the output determining unit M113 and executes a sequence (see FIG. 12) represented by the acquired sequence ED. The sequence control unit M114 stores the history information of executed autonomous operations in the history storing unit M124 in accordance with the sequence. In addition, the sequence control unit M114, during the execution of a sequence or within a time set in advance before/after the execution of a sequence, may store operation information for the target device U1-n of the sequence together with the history information of autonomous operations (see FIG. 16). This operation information is an operation executed by a user in addition to the autonomous operation within the sequence or instead of the autonomous operation within the sequence.

The sequence updating unit M115 updates the sequence based on the history information stored by the history storing unit M124 or version-up information of the sequence supplied from the outside. For example, the sequence updating unit M115 updates the sequence based on operation information representing an operation executed by the user in addition to the autonomous operation within the sequence or instead of the autonomous operation within the sequence.

The storage unit M12 is configured to include an information storing unit M121, a sequence storing unit M122, a notification information storing unit M123, and a history storing unit M124.

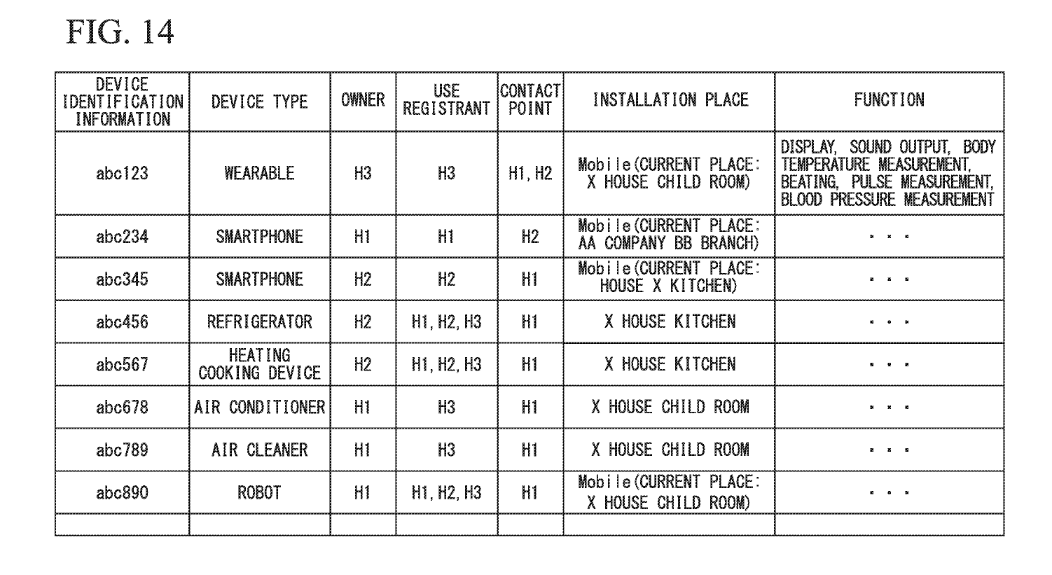

The information storing unit M121 stores the environment information, the device information, the person information, and the external information acquired by the information acquiring unit M111. In addition, the information storing unit M121 stores a device registration information table (see FIG. 14).

The sequence storing unit M122 stores a sequence correspondence information table (see FIG. 11) and a sequence information table (see FIG. 12).

The notification information storing unit M123 stores a notification information table (see FIG. 13). The notification information table is a table in which the environment information, the device information, the person information, or the external information and notification information are associated with each other through the sequence correspondence information table- and the sequence information table.

The history storing unit M124 stores the history information of autonomous operations executed by the sequence control unit M114. In addition, as described above, during the execution of a sequence or within a time set in advance before/after the execution of a sequence that is executed by the sequence control unit M114, the history storing unit M124 stores operation information for the target device U1-n of the sequence.

The communication unit M13 transmits and receives information, thereby communicating with external devices. The communication unit M13, for example, receives the environment information, the device information, and the person information from a plurality of devices U1-n and receives the external information from the information processing apparatus S1. The communication unit M13 transmits autonomous operation information, which represents an autonomous operation determined by the analysis unit M112, and includes the notification information determined by the output determining unit M113 to the target device U1-n to execute the autonomous operation and notification represented by the notification information.

### <Sequence Correspondence Information Table>

FIG. 11 is a schematic diagram illustrating one example of the sequence correspondence information table according to this embodiment

As illustrated in the drawing, the sequence correspondence information table includes columns of items including an identification number (No.), a condition, and a sequence ID. Here, the item of “condition” includes columns of items including the environment information, the operation information, the external information, and the person information. The item of “condition” is a condition for selecting a sequence ID. The sequence correspondence information table is data in the form of a two-dimensional table formed by rows and columns in which sequence correspondence information is stored for each identification number.

For example, sequence correspondence information of a first row (identification number “1”) illustrated in FIG. 11 represents that the sequence ID is determined as being as “12345” in a case in which the person information is “the body temperature is a threshold Th41 or more.” In addition, for example, sequence correspondence information of a second row (identification number “2”) illustrated in FIG. 1I represents that the sequence ID is determined as being as “23456” in a case in which the operation information is “the air conditioner is operated in the cooling mode,” and “returning of any one of family members is detected” as the person information.

### <Sequence Information Table>

FIG. 12 is a schematic diagram illustrating one example of the sequence information table according to this embodiment. As illustrated in the drawing, the sequence information table includes columns of items including a sequence ID, order, a branch, a condition, and autonomous operation information. Here, the item of “order” represents order in the sequence represented by each sequence ID. The item of “branch” represents identification information used for identifying each branch in a case in which an operation branches in accordance with a condition or the like within each order. The item of “condition” is a condition used for selecting the autonomous operation information. The item of “autonomous operation information” includes columns of items including a target device, an operation ID, and speech information, “operation ID” is identification information used for identifying an operation and represents an autonomous operation executed by a device U1-n represented by “target device.” “speech information” is one type of notification information and is a content pronounced by the device U1-n represented by “target” before an operation represented by “operation ID” is executed or when the operation is executed. This speech information includes a variable, and the variable is determined based on the environment information, the device information, the person information, or the external information.

The sequence information table is data in the form of a two-dimensional table formed by rows and columns in which sequence information is stored for each sequence ID. In addition, in each sequence, autonomous operation information is stored for each branch. In this table, “-” (hyphen) represents absence of information. For example, in a case in which “-” is set in the item of the autonomous operation information, it represents that an autonomous operation is not executed.

For example, first sequence information (sequence ID “12345”) illustrated in FIG. 12 represents that the sequence has six orders.

Order “1” represents an autonomous operation executed first in a case in which the sequence ID is determined as being “12345,” Here, order “1” is divided into branches “1-1” and “1-2” in accordance with two conditions including “presence of a contact point” and the otters (“others than description above”). As one of autonomous operations corresponding to branch “1-1,” the target device is “contact address communication device,” the operation ID is “1111,” and the speech information is “FEVER OF <NAME> IS <BODY TEMPERATURE> DEGREES. PLEASE CHECK STATE.” Here, “contact address communication device” is a communication device that is set in advance in the contact point (see FIG. 14).

In a case in which the autonomous operation of branch “1-1” is executed, <NAME> and <BODY TEMPERATURE> are variables in the speech information. In this case, based on the person information (a child H3 and body temperature “38” degrees) detected by a communication device (for example, a communication device 219-3 illustrated in FIG. 7) of a detection source of the body temperature and user information in which the user identification information and the name are associated with each other (the child H3 and MR. AA are associated with each other), the sequence control unit M114 substitutes <NAME> with “Mr. AA” and substitutes <BODY TEMPERATURE> with “38” degrees. In addition, in the case of the branch “1-2,” there is no autonomous operation, and thus, the operation of order is skipped.

The second order “2” represents an autonomous operation executed after the determination of the autonomous operation of the first order “1” (in a case in which there is no autonomous operation, after skipping order “1”). Here, order “2” is divided into branches “2-1,” “2-2,” and “2-3” in accordance with three conditions including “DETECTION OF PERSON AND PRESENCE OF DRINK,” “DETECTION OF PERSON AND NO PRESENCE OF DRINK,” AND “OTHERWISE” (“OTHER THAN DESCRIPTION ABOVE”).

The third order “3” represents an autonomous operation executed after the determination of the autonomous operation of the second order “2” (in a case in which there is no autonomous operation, after skipping order “1”). Here, order “3” is divided into branches “3-1” and “3-2” in accordance with two conditions including “2-1 COMPLETION & OPENING/CLOSING OF REFRIGERATOR” and “OTHERWISE (“OTHER THAN DESCRIPTION ABOVE”). In the condition of branch “3-1,” “2-1 COMPLETION” has selection of branch “2-1” and completion of the execution are set as one of the conditions. In other words, the condition of branch “3-1” is a condition that the refrigerator has been open as a result of the recommendation of a drink from the refrigerator in branch “2-1.” In other words, branch “3-1” represents a case in which it is estimated that the user has taken a drink present inside the refrigerator, and, in this case, the cooking device is caused to execute autonomous operation information of warming the drink.

### <Notification Information Table>

FIG. 13 is a schematic diagram illustrating one example of the notification information table according to this embodiment. As illustrated in the drawing, the notification information table includes columns of items including an operation ID, an entire pattern, a condition, light emitting places PR-1, PR-2, . . . , PR-M, and a sound. Here, the item of “entire notification pattern” represents a pattern for a notification at one light emitting place PR-m (m=1, 2, . . . , M) or a combination of notifications at a plurality of light emitting places PR-m. In addition, in a case in which one light emitting place PR-m has a pattern (local pattern) using a light emitting form, the entire pattern becomes different according to a difference in the local pattern. The item “condition” is a condition for selecting the notification pattern, “light emitting place PR-M” represents a notification pattern (light emitting form) according to light emission in a corresponding place. The item of “sound” represents a notification pattern using the sound.

The notification information table is data in the form of a two-dimensional table formed by rows and columns in which notification information is stored for each operation ID. In addition, in this table, “-” (hyphen) represents the absence of information. For example, in a case in which “-” is set in the item of the light emitting place PR-m, it represents that no light emission is executed.

For example, the second notification information (operation ID “3333” and entire notification pattern “2”) illustrated in FIG. 13 represents that, in a case in which “TARGET OBJECT IS PRESENT IN MIDDLE LEVEL OF LEFT SIDE OF REFRIGERATION ROOM,” the light emitting place PR-1 is caused to emit light in “PATTERN P21,” the light emitting place PR-3 is caused to emit light in “PATTERN P22,” and the speech information is pronounced. For example, the light emitting place PR-1 is the light emitting unit L11 illustrated in FIG. 4, and the light emitting place PR-1 is the light emitting unit L14 illustrated in FIG. 4. In this case, for example, as in Step St22 illustrated in FIG. 7, the refrigerator 213 is lighted and pronounces the speech information of the branch 2-1 illustrated in FIG. 12.

### <Device Registration Information Table>

FIG. 14 is a schematic diagram illustrating one example of the device registration information table according to this embodiment. As illustrated in the drawing, the device registration information table includes columns of items including device identification information, a device type, an owner, a use registrant, a contact point, an installation place, and a function. The device registration information table is data in the form of a two-dimensional table formed by rows and columns in which device registration information is stored for each device identification information.

For example, device registration information (device identification information “abc123”) of the first row illustrated in FIG. 14 is a communication device 219-3. This device registration information represents that the communication device 219-3 is a “wearable” device, and the owner is “child H3.” In addition, this device registration information represents that the use registrant of the communication device 219-3 is “child H3,” and the contact points are “the father H1” and “the mother H2.” Furthermore, this device registration information represents that there is no installation place (“mobile”) of the communication device 219-3, and the current place is “a child room of house X.” In addition, this device registration information represents that the communication device 219-3 has “a display function, a sound output function, a body temperature measurement function, a beating/pulse measurement function, and a blood pressure measurement function.

In addition, in the case illustrated in FIG. 14, for a device U1-n of which the installation place is fixed, as an example, the installation place is set in units of rooms.

### <Sequence of System>

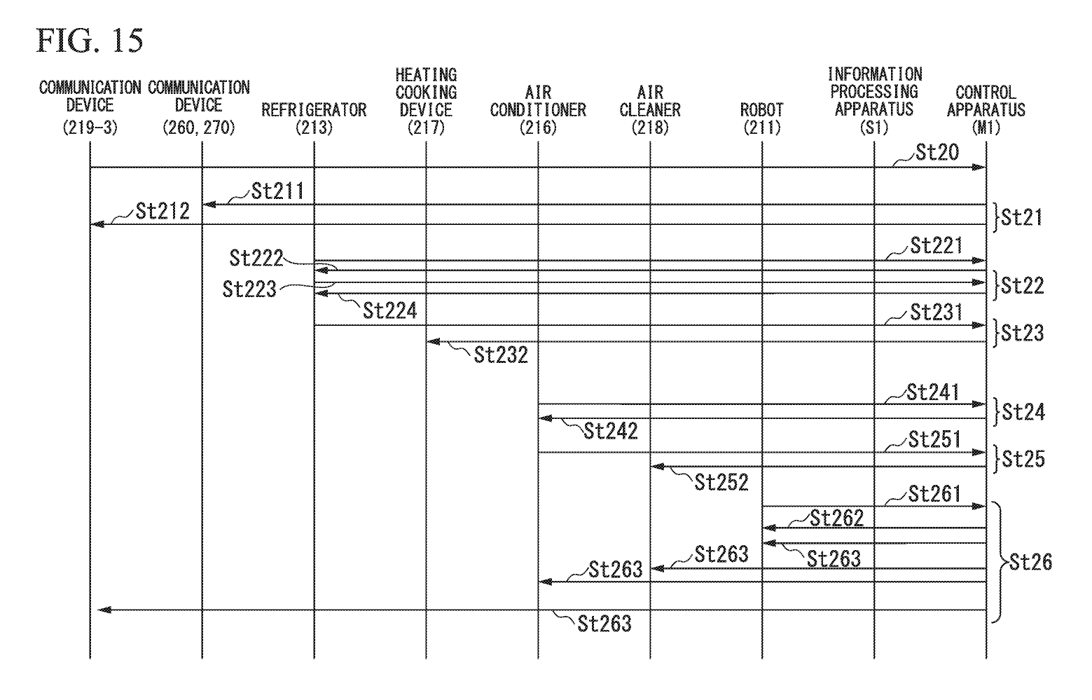

FIG. 15 is a schematic sequence diagram of the control system 1 according to this embodiment. In FIG. 15, a part to which the same reference sign as that of FIG. 7 is assigned represents correspondence between steps illustrated in FIGS. 7 and 15.

(Step St20) The communication device 219-3 transmits person information including the user identification information of a child H3 and the body temperature information of the child H3 and device information including the device identification information (“abc123”) of the communication device 219-3 to the control apparatus M1. The control apparatus M1 determines whether to execute an autonomous operation based on the received person information and the sequence correspondence information. For example, when the body temperature is 38 degrees, and the threshold Th41 is 37 degrees, in the case of the sequence correspondence information illustrated in FIG. 11, the control apparatus M1 determines the sequence ID as being “12345,” thereby determining that an autonomous operation is executed Thereafter, the process proceeds to Step St211.

(Step St211) The control apparatus M1 determines autonomous operation information based on the sequence ID determined in Step St20 and the sequence information table. For example, in the case of the sequence information table illustrated in FIG. 12, in order “1,” a condition (presence/absence of a contact point) is determined. The control apparatus M1 determines that a contact point is set in the device identification information (“abc123”) of the device that is the transmission source of Step S20 based on the device registration information table illustrated in FIG. 14. In this case, die control apparatus M1 determines “presence of a contact point” and selects branch “1-1.”

In this case, the control apparatus M1 determines portable devices (installation place “mobile”) of which the owners are the father H1 and the mother H2 that are contact points as contact address communication devices (“abc234” and “abc345” illustrated in FIG. 14). Here, devices U1-n of which the terminal identification information is “abc234” and “abc345” are respectively communication devices 260 and 270. The control apparatus M1 transmits autonomous operation information including the operation ID “1111” and the speech information “FEVER OF MR. AA HAS REACHED 38 DEGREES. PLEASE CHECK THE STATE” to the determined contact address communication devices (communication devices 260 and 270). Thereafter, the process proceeds to Step St212.

(Step St212) The control apparatus M1 determines the communication device 219-3 that has detected the body temperature as a detection source communication device. The control apparatus M1 transmits autonomous operation information including the operation ID “2222” and the speech information “FEVER HAS REACHED 38 DEGREES. CONTACT TO YOUR PARENTS HAS BEEN MADE, PLEASE WAIT FOR MOMENT.” to the determined detection source communication device (communication device 219-3). Here, the control apparatus M1 may check whether or not the communication device 219-3 (“abc23”) has a sound output function by referring to the item of “function” illustrated in FIG. 14. As results of Steps S211 and S212, the communication devices 260 and 270 and the communication device 219-3 executes the notification of Step St21 illustrated in FIG. 7. Thereafter, the process proceeds to Step St221.

(Step St221) The refrigerator 213, for example, detects the mother H2 and transmits person information representing that the mother H2 is present near the refrigerator 213 to the control apparatus M1. When the sequence ID is determined as being “12345,” or when it is in the standby state of order “2” (for example, within a time set in advance after the determination), the control apparatus M1 receives the person information transmitted by the refrigerator 213.

In this case, the control apparatus M1 determines that a person has been detected in order “2.” Thereafter, the process proceeds to Step St222.

(Step St222) The control apparatus M1 checks conditions that have not been checked for the conditions and variables of order “2.” In other words, the control apparatus M1 selects device identification information “abc456” (refrigerator 213) corresponding to the device type of “refrigerator” (target device illustrated in FIG. 12) illustrated in FIG. 14. The control apparatus M1, for the selected refrigerator 213, generates a detection direction for detecting whether or not a drink is present inside the refrigerator 213 and the position and the type of a drink (“drink” of the speech information) in a case in which the drink is present. The control apparatus M1 transmits the generated detection direction to the refrigerator 213. Thereafter, the process proceeds to Step St223.

(Step St223) The refrigerator 213 detects a drink based on the detection direction transmitted in Step St222. In a case in which a drink has been detected, the refrigerator 213 transmits device information representing the presence of the drink to the control apparatus M1. Here, in a case in which the position and the type of the drink have been detected, the refrigerator 213 transmits device information including information representing the position and the type of the drink to the control apparatus M1. Thereafter, the process proceeds to Step St224,

In addition, the control apparatus M1 may respectively execute checking of conditions and checking of variables in different steps. More specifically, after checking the conditions and determining an autonomous operation (branch), the control apparatus M1 may check variables relating to the determined autonomous operation.

(Step St224) The control apparatus M1 determines autonomous operation information based on the device information transmitted in Step St223 and the sequence information. For example, in a case in which a drink of which the type is a “sport drink” is present in the middle level of the left door side of the cold room, the control apparatus M1 transmits autonomous operation information including an operation ID “3333” and speech information “MR. AA HAS FEVER OF 38 DEGREES. BE CAREFUL FOR DEHYDRATION. HERE IS SPORT DRINK.” to the refrigerator 213. In addition, in this autonomous information, the notification information of the entire notification pattern “2” illustrated in FIG. 13 is included. As a result, the refrigerator 213 executes the notification of Step St22 illustrated in FIG. 7. Thereafter, the process proceeds to Step St231.

(Step St231) The refrigerator 213 transmits device information representing the completion of the autonomous operation of the branch “2-1” to the control apparatus M1. In a case in which the opening/closing of the refrigerator is detected within a time set in advance after that, the refrigerator 213 transmits device information representing opening/closing of the refrigerator to the control apparatus M1. When the sequence ID “12345” is determined, or when it is in the standby state of order “3,” the control apparatus M1 receives the device information transmitted by the refrigerator 213. Thereafter, the process proceeds to Step St232.

(Step St232) The control apparatus M1, for example, determines that the autonomous operation of branch “2-1” has been completed and thereafter, the door of the refrigerator 213 has been open and closed based on the device information transmitted by the refrigerator 213. In other words, the control apparatus M1 determines that the sport drink has been taken out from the refrigerator 213 as a result of the autonomous operation of branch “2-1” and selects branch “3-1.” In this case, the control apparatus M1 selects device identification information “abc567” (cooking device 217) corresponding to a device installed in the same room (the kitchen of the house X) as that of the refrigerator 213 (device identification information “abc456”) among devices of which the device type illustrated in FIG. 14 is “cooking device.” The control apparatus M1 transmits autonomous operation information including operation ID “5555” and speech information “DO YOU WANT ME TO WARM SPORT DRINK? IN CASE OF FEVER, IT IS BETTER TO WARM IT UP TO 30 DEGREES.” to the selected cooking device 217. Here, the control apparatus M1 takes over the variables of “drink” of branch “2-1” as the variables of “drink” and, as a result, substitutes “sport drink” into the variable of “drink” of branch “3-1.” As a result, the cooking device 217 executes the notification of Step St23 illustrated in FIG. 7. Thereafter, the process proceeds to Step St241.

In this way, the cooking device 217 executes the autonomous operation in association with the completion of the autonomous operation of another device U1-n (refrigerator 213) or the completion of an operation according to this autonomous operation.

In other words, in accordance with the presence/absence of the autonomous operation of the refrigerator 213 and the presence/absence of an operation according to this autonomous operation, the cooking device 217 executes an autonomous operation or not, or the details of the autonomous operation are changed.

(Step St241) The air conditioner 216, for example, detects a child H3 and the mother H2 and transmits person information representing that the child H3 and the mother H2 are present in the child room of the house X (the room in which the air conditioner 216 is installed) to the control apparatus M1. In addition, the air conditioner 216 detects a room temperature and humidity and transmits environment information representing the room temperature and the humidity that have been detected to the control apparatus M1. Furthermore, the air conditioner 216 may transmit device information representing a set temperature to the control apparatus M1.

When the sequence ED is determined as being “12345” or when it is in the standby state of order “4,” the control apparatus M1 receives the person information, the environment information, and the device information that have been transmitted by the air conditioner 216. Thereafter, the process proceeds to Step St242.

(Step St242) The control apparatus M1, for example, determines that the room temperature is a threshold Th61 or less based on the room temperature represented by the environment information. In other words, the control apparatus M1 determines that the room is cold and selects branch “4-1.” In this case, the control apparatus M1 reads information in which the room temperature, the operation mode, and the set temperature of a case in which a person having a fever is present are associated with each other from the storage unit M12 and determines the operation mode and the set temperature based on the read information and the environment information (for example, a set temperature “24” degrees in the operation mode “heating”). In addition, the control apparatus M1 selects device identification information “abc678” (air conditioner 216) corresponding to a device installed in the room in which the child H3 is present (the child room of the house X) among devices of which the device type illustrated in FIG. 14 is “air conditioner.” The control apparatus M1 transmits autonomous operation information including operation ID “6666” and speech information “IN CASE OF FEVER, BODY NEEDS TO BE WARMED NOT TO BE COOLED DOWN. IN CASE OF CURRENT ROOM TEMPERATURE, YOU'D BETTER SET ABOUT 24 DEGREES THROUGH HEATING” to the selected air conditioner 216. As a result, the air conditioner 216 executes the notification of Step St24 illustrated in FIG. 7. Thereafter, the process proceeds to Step St251.

(Step St251) The air conditioner 216 transmits device information representing the completion of the autonomous operation of branch “4-1” to the control apparatus M1. When the sequence ID is determined as being “12345” or when it is in the standby state of order “5,” the control apparatus M1 receives the device information that has been transmitted by the air conditioner 216. Thereafter, the process proceeds to Step St252.

(Step St252) The control apparatus M1, for example, determines that the autonomous operation of branch “2-1” has been completed based on the device information transmitted by the air conditioner 216. In other words, the control apparatus M1 determines that the autonomous operation of branch “4-1” has been completed and selects branch “5-1.” In this case, the control apparatus M1 selects device identification information “abc789” (air purifier 218) corresponding to a device installed in the same room (the child room of the house X) as that of the air conditioner 216 (device identification information “abc678”) among devices of which the device type illustrated in FIG. 14 is “air purifier.” The control apparatus M1 transmits autonomous operation information including operation ID “7777” and speech information “AIR NEEDS TO BE CLEANED. PLEASE USE HUMIDIFICATION FUNCTION SUCH THAT AIR IS NOT DRY.” to the selected air purifier 218. As a result, the air purifier 218 executes the notification of Step St25 illustrated in FIG. 7. Thereafter, the process proceeds to Step St261.

In addition, in Step St25, the air purifier 218 detects that the amount of water to be used for the humidifying function is small and additionally pronounces speech information urging the supplement of water. In addition, in a case in which die humidifying function is not included in the function illustrated in FIG. 14 for the selected air purifier 218, the control apparatus M1 may exclude a part relating to the humidifying function from the speech information. In such a case, the control apparatus M1 may change the speech information of this part to different speech information. For example, the control apparatus M1 sets the speech information as “THE AIR NEEDS TO BE CLEAN. PLEASE PREPARE A WET TOWEL SUCH THAT THE AIR BECOMES NOT DRY”

(Step St261) The robot 211, for example, detects a case according to the mother H2 (for example, generation of speech including “thank you”) and transmits person information representing an expression of gratitude to the control apparatus M1. In addition, the robot 211 transmits device information representing the current position of its own device (a room in which a person giving speech of an expression of gratitude is present; for example, the child room of the house X) to the control apparatus M1. When the sequence ID is determined as being “12345” or when it is in the standby state of order “6,” the control apparatus M1 receives the person information and the device information that have been transmitted by the robot 211. Thereafter, the process proceeds to Step St262.

(Step St262) The control apparatus M1 determines that one of branches “1-1,” “2-1,” “2-2,” “3-1,” “4-1,” and “5-1” has been executed, in other words, at least one of autonomous operations within a sequence having sequence ID “12345” has been executed. In addition, it is determined that the robot 211 has detected an expression of gratitude. In other words, the control apparatus M1 determines that an autonomous operation within the sequence has been smoothly executed, and the user gives an expression of gratitude and selects branch “6-1.”

In this case, the control apparatus M1 selects device identification information “abc890” (robot 211) corresponding to a device presented in a room represented by the device information among devices of which the device type illustrated in FIG. 14 is “robot” the control apparatus M1 transmits autonomous operation information including operation ID “8888” and speech information “I HOPE YOU RECOVER SOON.” to the selected robot 211. Thereafter, the process proceeds to Step St263.

(Step St263) The control apparatus M1 selects all the devices of which the installed positions are the room that is the current position of the robot 211 based on the autonomous operation information of branch “6-1.” For example, in the case illustrated in FIG. 14, the control apparatus M1 selects device identification information “abc123” (communication device 219-3), “abc678” (air conditioner 216), “abc789” (air purifier 218), and “abc890” (robot 211) corresponding to devices of which installed positions are “the child room of the house X” The control apparatus M1 transmits autonomous operation information including operation CD “9999” to the communication device 219-3, the air conditioner 216, the air purifier 218, and the robot 211 that have been selected.

As a result of such Steps St262 and St263, the air conditioner 216, the air purifier 218, and the robot 211 execute the notification of Step St26 illustrated in FIG. 7. Thereafter, the control apparatus M1 completes the sequence having sequence ID “12345.”

### <History Information Log>

FIG. 16 is a schematic diagram illustrating one example of a history information log according to this embodiment. This diagram is one example of the history information of a case in which the sequence illustrated in FIG. 15 is executed. As illustrated in the drawing, the history information log includes a columns of items including a sequence ID, an order, date and time, and output Here, “date and time” represent time when a target device executes an operation.

For example, first history information illustrates in FIG. 16 represents an operation executed in the “1”st order after the sequence ID is determined as being “123456.” This history information is history information of a case in which Step St21 illustrated in FIG. 7 is executed. This history information represents that, at “2015/XX/XX 08:30,” communication devices 260 and 270 execute an operation represented by operation ID “1111” and pronounces that “FEVER OF MR. AA HAS REACHED 38 DEGREES. PLEASE CHECK THE STATE” In addition, this history information represents that, at “2015/XX/XX 08:30,” a communication device 219-3 executes an operation represented by operation ID “2222.”

In addition, history information of which the order illustrated in FIG. 16 is the “4”th is an operation information (or an operation based on manipulation) according to a user. This history information represents that, after the autonomous operation of Step St23 illustrated in FIG. 7, the user turns on the switch (presses a start button) of the cooking device 217 with a set temperature of 40 degrees. In other words, it represents that the user has warmed the sport drink up to 40 degrees regardless of the proposal of 30 degrees in Step St23.

History information of which the order is “9”th order illustrated in FIG. 16 is operation information not relating to the sequence having sequence ED “12345” illustrated in FIG. 12. This history information represents that a phone connection is made to have a phone call from the communication device 270 of the mother H2 to the communication device 260 of the father H1.

### <Update of Sequence>

The sequence updating unit M115 updates the sequence information based on the history information (for example, FIG. 16) stored by the history storing unit M124.

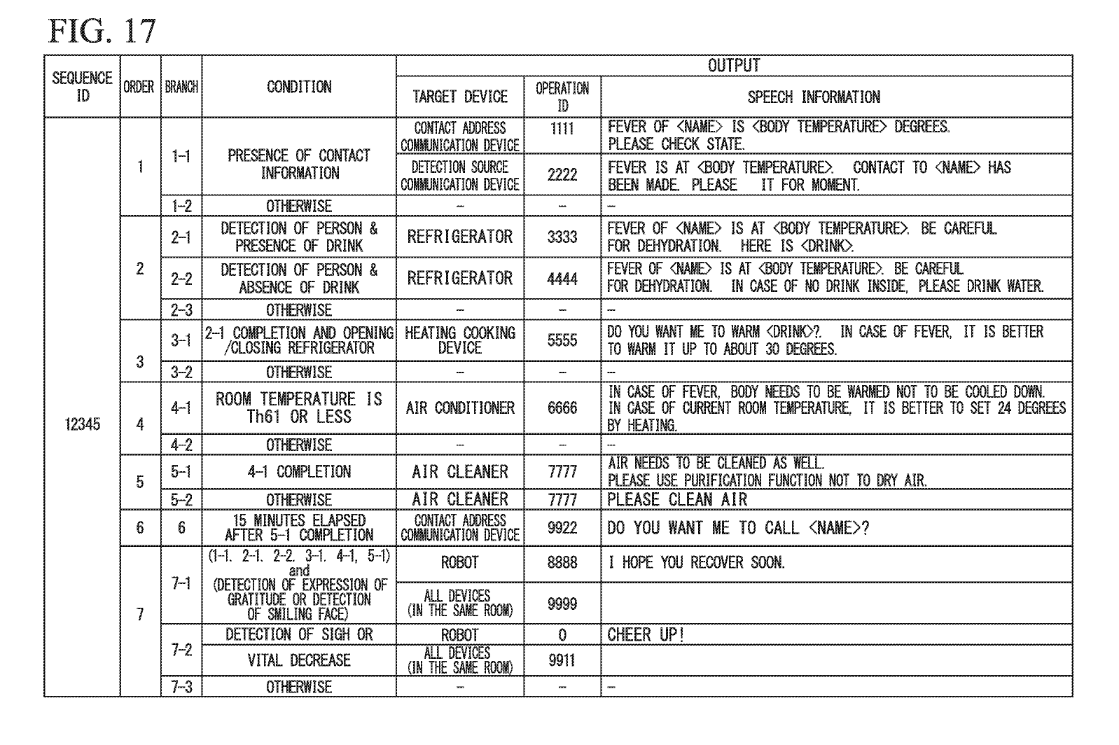

FIG. 17 is a schematic diagram illustrating one example of the sequence information table after update according to this embodiment. The sequence information table illustrated in FIG. 17 is acquired by updating the sequence information table illustrated in FIG. 12 using the sequence updating unit M115.

The sequence information table, similar to FIG. 12, includes columns of items including a sequence ID, an order, a branch, a condition, and autonomous operation information. By comparing the sequence information table illustrated in FIG. 17 with the sequence information table illustrated in FIG. 12, the followings (A1) and (A2) are different.

(A1) “30” degrees is changed to “40 degrees” in the speech information of the autonomous operation information of branch “3-1.”

(A2) Order “6” is added. The autonomous operation of order “6” causes the contact address communication devices (communication devices 260 and 270) to execute an operation having operation ID “9922” and to pronounce “DO YOU WANT ME TO CALL <NAME>?” In this <NAME>, the name of the owner of the contact point communication device different from the target device is substituted. For example, the communication device 270 of the mother H2 pronounces “DO YOU WANT MB TO CALL FATHER H1?,” and the communication device 260 of the father H1 pronounces ““DO YOU WANT ME TO CALL MOTHER H2”

The update to (A1) described above is changing the proposed set temperature to a set temperature according to an operation using the sequence updating unit M115 in a case in which another set temperature is set in the operation after the proposal of the set temperature (30 degrees). In other words, in a case in which, in a proposed autonomous operation, an operation for a setting different from the proposal is executed, the sequence updating unit M115 changes the setting of the proposal (the setting in the sequence information illustrated in FIG. 12) to the setting made in the operation.

In addition, the sequence updating unit M115 may store “the mother” who is die subject of the temperature setting (40 degrees) in the “4”th order illustrated in FIG. 16 in association with “set temperature 40 degrees.”

In such a case, the sequence control unit M114 can execute the sequence updated in a case in which the subject warming the sport drink is recognized as “the mother.”

The update to (A2) described above is adding an operation to the sequence using the sequence updating unit M115 in a case in which the operation that is not present in the sequence is executed during the execution of the sequence or within a time set in advance before/after the execution of the sequence. In other words, in a case in which an operation different from that of the proposal is executed in the executed sequence, the sequence updating unit M115 adds an autonomous operation relating to this operation to the sequence (the sequence information illustrated in FIG. 12).

### <Summary>

As above, in the control system 1, the storage unit M12 stores the correspondence information (FIGS. 11,12, and 13) in which at least two pieces of information among the environment information, the person information, and the device information detected by each device U1-n and the external information provided by the external device and the autonomous operation information including the operation information of the device (operation ID) and the notification information representing a notification using a sound, a light, or an image of the device are associated with each other. The control unit M11 acquires at least two pieces of information among the environment information, the person information, the device information and the external information. The control unit M11 determines autonomous operation information based on the correspondence information and the at least two pieces of information that have been acquired. The input/output unit U13-n executes a notification, which is a notification corresponding to an operation based on the operation information, using a sound, a light, or an image in accordance with the notification information based on the autonomous operation information determined by the control unit M11.

Here, in the control system 1, the device U1-n includes the operation unit U12-n exerting the function of its own device U1-n and the input/output unit U13-n receiving a direction from a user or the sensor unit U11-n. The communication unit U16-n transmits the environment information, the person information, and the device information detected by its own device U1-n and receives the autonomous operation information, which is autonomous operation information based on the environment information, the person information, or the device information detected by another device, including the notification information corresponding to the operation of its own device. The light emitting unit U133-n, based on the autonomous operation information, executes a notification, which is a notification corresponding to the operation of its own device U1-n, using a sound, a light, or an image in accordance with the notification information.

In this way, in the control system 1, an autonomous operation is determined in consideration of the environment information, the device information, the person information, or the external information, and each device can propose the determined autonomous operation to the user. Here, in the control system 1, since at least two pieces of information among the environment information, the device information, the person information, and the external information are used, and accordingly, compared to a case using one piece of information, a deep content can be proposed. In this way, in a case in which a proposal desired by the user can be made, the user feels pleasure, and accordingly, the control system 1 can inspire emotion in the user. Here, the environment information, the device information, the person information, or the external information is information experienced by the user, information in which the user is interested, or information admired by the user. Since each device proposes an autonomous operation based on such information, the user feels that each device understands him and makes a proposal. In this way, since the user feels pleasure due to die device, the control system 1 can inspire emotion in the user.

In this way, in the control system 1, a person can sympathize with the device U1-n.

In addition, in the control system 1, the autonomous operation information includes the identification information of the device, the operation information of the device, and the notification information representing a notification using a sound, a light, or an image. In addition, the identification information (device identification information) of the device may be associated in accordance with the correspondence between the “target device” illustrated in FIG. 12 and the “device type” illustrated in FIG. 14. The control unit M11 determines the device identification information based on the correspondence information and at least two pieces of information that have been acquired. The input/output unit U13-n of the device U1-n represented by the device identification information determined by the control unit M11 executes a notification, which is a notification corresponding to an operation based on the operation information, using a sound, a light, or an image.

In this way, in the control system 1, for each device, for example, the operation information and the notification information according to the function of the device or the status can be determined and can be proposed to the user.

In addition, in the control system 1, the storage unit M12 stores the correspondence information in which at least two pieces of information and a plurality of pieces of device identification information are associated with each other. The control unit M11 determines a plurality of pieces of device identification information based on the correspondence information and at leas two pieces of information that have been acquired. The input/output units U13-n of devices represented by the plurality of pieces of device identification information determined by the control unit M11 executes different notifications.

In this way, in the control system 1, by using the plurality of devices U1-n, for example, the operation information and the notification information according to the function of the device U1-n and the situations can be determined and can be proposed to the user. The user feels like that the plurality of devices U1-n cooperates for a proposal. In this way, since the user memories the integrated feeling, the control system 1 can inspire emotion in the user.

In addition, in the control system 1, also in a case in which the function is insufficient in one device U1-n, the insufficiency of the function may be supplemented by the other devices U1-n. In this way, compared to the case of one device U1-n, the control system 1 can make a new proposal or many proposals.

In addition, in the control system 1, the input/output unit U13-n or the sensor unit U11-n (direction input unit) receives the input of a direction from the user, for example, in accordance with pressing of a button, speech, a remote control, or the like. After the input/output unit U13-n executes a notification, the sequence updating unit M115 changes the correspondence information based on the direction input to the input/output unit U13-n or the sensor unit U11-n (see FIG. 17).

In a case in which another direction is made after the proposal using the notification, it is considered that the user prefers the content of the another direction to the proposal. In the control system 1, since the correspondence information is changed based on a direction after the execution of the notification, a proposal that matches the user's preference can be made after the change.

Since the proposal is changed to be preferred by the user, the user feels that each device understands him and makes the proposal. In this way, the user feels pleasure due to the device, and accordingly, the control system 1 can inspire emotion in the user.

In addition, in the control system 1, the communication unit U16-n may transmit correspondence information for the target device U1-n to the target device U1-n executing an operation. In this case, the target device U1-n may include an information acquiring unit M111, an output determining unit M113, a sequence control unit M114, and a sequence storing unit M122. The output determining unit M113 of the target device U1-n may determine autonomous operation information based on the correspondence information transmitted by the communication unit U16-n and at least two pieces of information among the environment information, the device information, the person information, and the external information acquired by the communication unit U16-n. In addition, the information acquiring unit M111 of this case may be the input unit U131-n or the sensor unit U11-n.

For example, in the control system 1, the integration of a plurality of devices U1-n may be executed by the control apparatus M1, and details of the operation of each device U1-n may be set or adjusted on the device U1-n side. For example, in a case in which a room is to be cooled, the control apparatus M1 executes control of operating the air conditioner 216 in the cooling mode, turning on the power of an electric fan, turning on the power of the air purifier 218, and the like. The temperature setting of the air conditioner 216, the amount of wind of the electric fan, an ion mode (only negative ions, only positive ions, or both positive and negative ions) of the air purifier 218 may be determined and set by each device U1-n based on the correspondence information (for example, the conditions illustrated in FIG. 12).

In addition, in the control system 1, although a case in which the control apparatus M1 includes the control unit M11 (operation determining apparatus) has been described, the device U1-n may include the control unit M11 (operation determining apparatus).

In such a case, the control unit M11 of the device U1-n reads the correspondence information (FIGS. 11, 12, and 13) in which at least two pieces of information among the environment information, the person information, and the device information detected by each device U1-n and the external information provided by an external device and the autonomous operation information including the operation information (operation ID) of the device and the notification information representing a notification using a sound, a light, or an image of the device are associated with each other from the storage unit. The control unit M11 acquires at least two pieces of information among the environment information, the person information, the device information, and the external information. The control unit M11 determines the autonomous operation information based on the correspondence information and the at least two pieces of information that have been acquired. In addition, there are cases in which the light emitting device (light emitting place) for the notification information is different in the device U1-n including a plurality of light emitting devices. In other words, the control unit M11 determines a light emitting device (light emitting place) based on the environment information, the person information, and the device information detected by each device U1-n or the external information provided the external device.

In addition, in the control system 1, the control unit M11 determines the autonomous operation information based on the correspondence information and at least two pieces of information among the environment information, the person information, the device information, and the external information.

Here, in the autonomous operation information, a notification pattern creating a feeling of vitality, warmth, or ballottement is included. In other words, the control unit M11 determines the function, the benefit, or the effect of each device U1-n or a state in which the function, the benefit, or the effect of each device U1-n is exerted based on at least two pieces of information among the environment information, the person information, the device information, and the external information. The control unit M11 determines a representation corresponding to the function, the benefit, or the effect of each device U1-n or a state in which the function, the benefit, or the effect of each device U1-n is exerted that is a representation (notification pattern) representing these. More specifically, based on at least two pieces of information among the environment information, the person information, the device information, and the external information, the control unit M11 determines that desired object is present inside the room of the refrigerator, desired information is displayed on the television set, a desired temperature can be achieved by air conditioning, a food ingredient can be warmed through heating, and the air can be cleaned by generating ions or the like. In order to represent the function, the benefit, the effect, or the like of each device U1-n that has been determined, the control unit M11 selects the opening parts of the refrigerators 213 and 223, the peripheries of the screens of the television sets 213 and 223, the air outlet ports of the air conditioners 216 and 226, the inside of the chamber of the cooking device 217, a part of the air purifier 218 in which an ion generator is mounted, a blowout port thereof, or the periphery thereof, or a part relating thereto. In addition, the control unit M11 determines a notification pattern of the light emitting form representing the function, the benefit, the effect, or the like of each device U1-n for the selected part. For example, the control unit M11 determines a notification pattern emitting light using a certain color of a warm color system in a case in which warming or being warm is to be represented and a notification pattern emitting light using a color of a cool color system in a case in which cooling or being cold is to be represented. Based on at least two pieces of information among the environment information, the person information, the device information, and the external information, the control unit M11 determines a notification pattern having a light emission time, the shape of light emission, a light emission coefficient, and the like corresponding thereto. In this way, in the control system 1, the control unit M11 can represent not only a simple display of only a state, a direction or a warning but the function, the benefit, or the effect of each device U1-n or a state in which each device U1-n exerts the function, the benefit, or the effect in each device. In this way, the user feels like that each device U1-N has consciousness and has an emotion following him, and accordingly, each device U1-n can create an emotional value for the user.

### Third Embodiment

Hereinafter, a third embodiment of the present invention will be described in detail with reference to the drawings. In the third embodiment, another example of a use case of the control system 1 according to the first or second embodiment will be described.

In the third embodiment, a case in which an air conditioner 216 starts an automatic operation or a case in which the air conditioner 216 executes automatic control during the operation will be described.

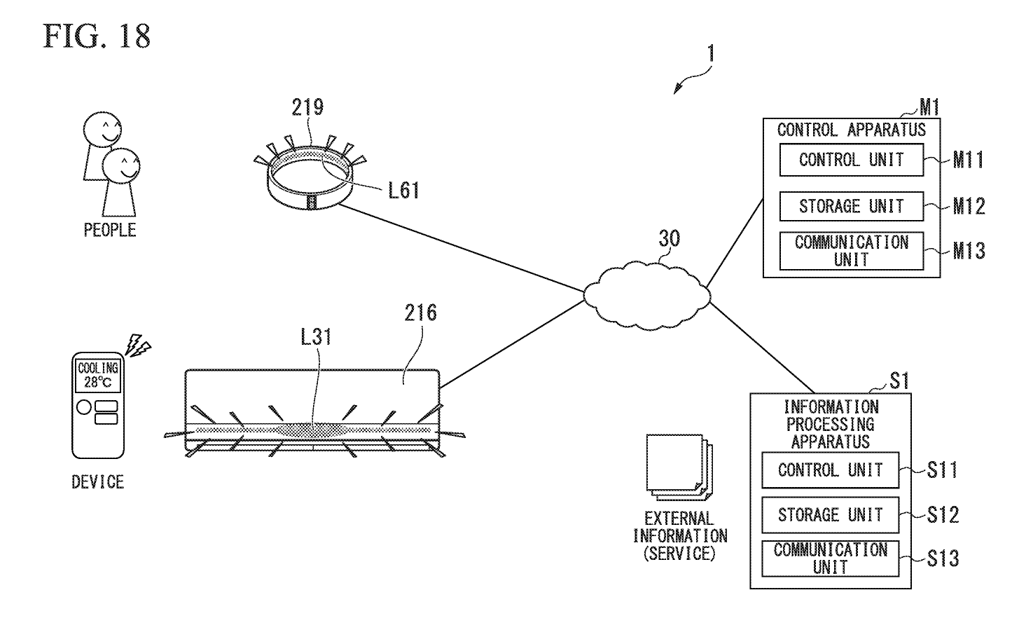

FIG. 18 is a functional block diagram illustrating a schematic configuration of a control system 1 according to a third embodiment of the present invention.

A control unit M11 acquires information representing detection of a person, individual authentication information or personal data (vital data or the like) as person information. For example, the control unit M11 acquires such information from a communication device 219 or the air conditioner 216. For example, the individual authentication information is acquired by detecting a face using the air conditioner 216 and specifying a person based on the feature amounts thereof, hi addition, the individual authentication information is information specifying a person based on ID/PW or the registration information of an owner or the like using the communication device 219 that is a wearable device or communication devices 260 and 270 that are smartphones.

Furthermore, the control unit M11 acquires device information that represents setting information or operation information. Here, the operation information may be information based on the control of a target device U1-n using an external device. In addition, the control unit M11 acquires external information from an information processing apparatus S1. The external information, for example, is information representing a weather forecast.

The control unit M11 causes the air conditioner 216 to execute an operation or a notification by being triggered upon the next information.

The control unit M11 uses acquired information for the trigger or the operation.

The air conditioner 216 may be based on a timer by being triggered upon turning on/off of the power. When it is time set in advance or when a time set in advance elapses, the control unit M11 causes the ail conditioner 216 to execute an operation or a notification.

In addition, by being triggered upon turning on/off the power of the air conditioner 216, the air conditioner 216 may be based on a set temperature represented by the device information and an air temperature (outer air temperature) represented by the external information or an air temperature (a room temperature or the temperature of the inside of the car) represented by the environment information. The control unit M11 causes the air conditioner 216 to execute an operation or a notification in accordance with a trigger based on such a set temperature or the air temperature and a threshold or a trigger based on such a set temperature or a difference from the air temperature and a threshold.

In addition, the trigger for turning on/off of the power of the air conditioner 216 may be based on operation information represented by the device information.

The control unit M11 determines operation information (an operation ID or the like) or notification information of the air conditioner 216 based on the next information. For example, the control unit M11 causes the air conditioner 216 to execute the operation or the notification that has been determined during the operation of the air conditioner 216. Here, in the operation information of the air conditioner 216, turning on or turning off of the power of the air conditioner 216 is included.

As information used for determining the operation information of the air conditioner 216, there is setting information of a person represented by the device information or individual authentication information represented by the person information. For example, the control unit M11 determines the operation information or the notification information in accordance with the setting information of the person and the individual authentication information.

As information used for determining the operation information of the air conditioner 216, there is vital data represented by the person information. For example, in a case in which it is determined that the vital data represents an abnormality of the body (for example, in a case in which a fever is determined), the control unit M11 determines operation information or notification information that is a countermeasure for the abnormality. In addition, by referring to the setting information of a person, switching between settings of the temperature and the like may be executed in accordance with the recognized person.

The control unit M11 gives an operation start direction to the air conditioner 216 or directs the air conditioner 216 to execute control during the operation based on the determined operation information. The air conditioner 216 executes start of the operation or control during the operation based on the operation information.

The control unit M11 directs the air conditioner 216 to execute a notification based on the determined notification information. The air conditioner 216 executes a notification corresponding to an operation represented by the operation information at the time of string the operation or during the operation based on the notification information.

Hereinafter, a specific example of the notification will be illustrated.

(B1) In a case in which an operation of start blowing the wind is executed, the air conditioner 216 illuminates the periphery of an air outlet port. In other words, in correspondence with an operation of starting to blow the wind, the air conditioner 216 illuminates a part (light emitting unit L31) acting on the user in accordance with this operation. In addition, for example, in a case in which an operation of automatically cleaning a filter is executed, the air conditioner 216 illuminates the surface of a casing in which the filter is stored or a part (frame) thereof following the outer periphery of the filter. In other words, in the operation of automatically cleaning the filter, the air conditioner 216 illuminates a part executing this operation.

(B2) The air conditioner 216 emits light in accordance with an operation status. Here, the operation status, for example, is the status of a fan or a compressor and, more particularly, is the output

(B3) The air conditioner 216 emits light in accordance with an operation mode. For example, the air conditioner 216 emits light using a cool color system (blue or a water color) in the case of a cooling mode and emits light using a warm color system (orange or red) in the case of a heating mode.

(B4) The air conditioner 216 changes the light emitting form in a case in which light emission is changed. For example, the air conditioner 216 changes the color of light of a lighting method (blinking or a method of change) in the light emission.

(B5) The air conditioner 216 represents recommendation (proposed content) for the user using the light emitting form. For example, in a case in which it is predicted to be getting warmer using the weather forecast, the air conditioner 216 pronounces that “SINCE IT IS GETTING WARMER FROM NOW ON, IT IS RECOMMENDED TO INSERT COOLER.” In such a case, for example, the air conditioner 216 executes blinking three times using an orange color (representing it is getting warmer) and thereafter, executes light emission (representing a cooler) blurring using a water color for three seconds. The air conditioner 216 repeats this light emission pattern. In addition, in order to blur the color, a diffusion plate may be installed on the light emission side of the light emitting unit, or the image may be blurred. In a case in which the image is blurred, based on a pixel value of a certain pixel, the pixel values of surrounding pixels of the pixel are determined.

(C1) The air conditioner 216 outputs a sound (BGM or the like) according to an operation status. Here, the operation status, for example, is the status of the fan or the compressor and, more particularly, is the output

(C2) The air conditioner 216 outputs a sound according to the operation mode.

(C3) In order to allow a user to notice light emission, the air conditioner 216 outputs a sound urging attention.

### Fourth Embodiment

Hereinafter, a fourth embodiment of the present invention will be described in detail with reference to the drawings. In the fourth embodiment, another example of a use case of the control system 1 according to the first or second embodiment will be described.

In the fourth embodiment, a case in which a refrigerator 213 indicates whether an object is present inside a room will be described.

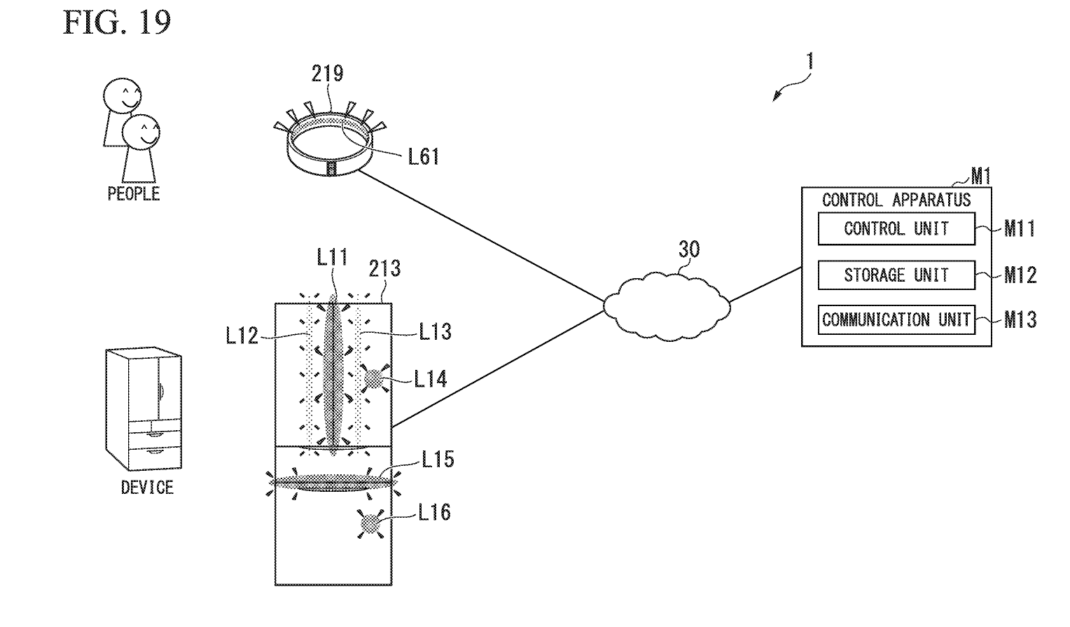

FIG. 19 is a functional block diagram illustrating a schematic configuration of the control system 1 according to the fourth embodiment of the present invention.

A control unit M11 acquires information representing detection of a person, individual authentication information or personal data (vital data or the like), and generated speech information as person information. For example, the control unit M11 acquires such information from a communication device 219 or the refrigerator 213.

In addition, the control unit M11 acquires device information representing setting information or operation information. Here, the operation information may be information based on control using an external device of a target device U1-n. In addition, the control unit M11 acquires external information from an information processing apparatus S1. For example, the external information is information representing a recipe of cooking.

The control unit M11 causes the refrigerator 213 to execute an operation or a notification by being triggered upon the next information. The control unit M11 uses acquired information for the trigger or the operation.

For example, in a case in which generated speech information acquired from the refrigerator 213 represents “being thirsty,” the control unit M11 illuminates an opening part (light emitting unit L11) of the refrigerator 213. In addition, in a case in which device information representing a place in which a drink is placed is acquired from the refrigerator 213, the control unit M11 illuminates a part (the light emitting units L14 and L16) representing the place in which a drink is placed. Alternatively, the control unit M11 may direct the refrigerator 213 to illuminate a part in which a drink is placed.

For example, in a case in which the body temperature represented by person information acquired from the communication device 219 exceeds a threshold, in other words, in a case in which it is detected that a person has a fever, the control unit M11 illuminates the opening part of the refrigerator 213. In addition, in a case in which device information representing a place in which a drink is placed is acquired from the refrigerator 213, the control unit M11 illuminates a part representing the place in which a drink is placed. Here, as will be described later, the control unit M11 represents high urgency using the light emitting form.

For example, in accordance with the acquired information (for example, the value of the vital data), the control unit M11 determines a light emitting form and speech information.

For example, based on the generated speech information acquired from the refrigerator 213, the control unit M11 specifies a food ingredient requested by the user. For example, in a case in which the generated speech information acquired from the refrigerator 213 is “Is broccoli present,” “broccoli” that is a noun representing a food ingredient is specified through a morphological analysis or the like. The control unit M11 determines whether or not the specified food ingredient is present inside a room. More specifically, the control unit M11 acquires a food ingredient table in which an object (a food ingredient or the like) present inside a room is associated with a place in which the object is placed from the refrigerator 213 as device information. The control unit M11 determines whether or not the specific food ingredient is present in the food ingredient table.

In a case in which it is determined that the specified food ingredient is present inside the room, the control unit M11 illuminates the opening part of the refrigerator 213. In addition, in a case in which a place in which the specified food ingredient is placed is registered in the food ingredient table, the control unit M11 illuminates a part representing the place in which the specified food ingredient is placed. In addition, in a case in which a place in which the specified food ingredient is placed is not registered (in the case of null) in the food ingredient table, the control unit M11 illuminates a place, in which the food ingredient is to be originally present, registered in advance. For example, in a case in which the food ingredient is vegetable, the control unit M11 illuminates a vegetable room.

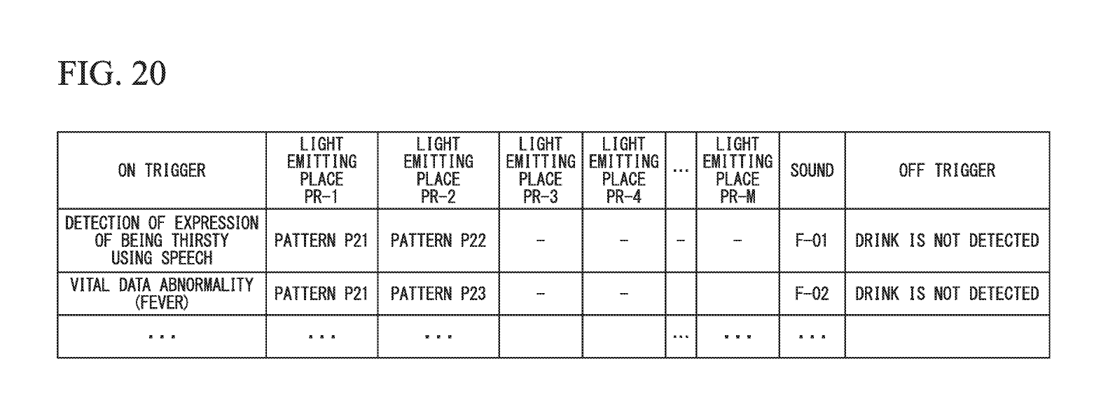

In addition, a storage unit U15-n or a storage unit M12 may store a notification information table (FIG. 20) for each object (food ingredient). The control unit M11 may select a notification information table in accordance with a specified food ingredient, start light emission using a notification pattern for each light emitting place and pronunciation in accordance with a trigger (on trigger) represented by the notification information table, and end the light emission and the pronunciation in accordance with a trigger (off trigger) for stopping the notification.

The control unit M11 directs the refrigerator 213 to execute a notification based on the determined notification information. The refrigerator 213 executes a notification corresponding to a recommended (proposed) operation based on the notification information.

Hereinafter, a specific example of the notification will be illustrated.

(D1) In a case in which a user is allowed to open the door, the refrigerator 213 illuminates the opening part or the periphery thereof. In other words, in correspondence with an operation recommended to the user (an operation of opening the door), the refrigerator 213 illustrates a part that brings the benefit to the user.

(D2) In a case in which a drink is recommended to the user, the refrigerator 213 illuminates the opening part or a part representing a place in which a drink is placed. In other words, the refrigerator 213 illuminates a part achieving the object or the desire of the user. More specifically, in correspondence with an operation of recommending an object, the refrigerator 213 illuminates a place in which the object is present or a place that is operated for acquiring the object

(D3) The refrigerator 213 executes light emission in accordance with the acquired information. For example, by using the acquired person information, in a case in which it is determined that a person feels thirsty and in a case in which it is determined that a person has a fever, the refrigerator 213 uses different light emitting forms. For example, in a case in which it is determined that a person feels thirsty, the refrigerator 213 emits light using a cool color system (blue or a water color) and blinks using a warm color system (orange or red) in a case in which it is determined that a person has a fever. In this way, in a case in which it is determined that a person has a fever, the refrigerator 213 represents higher urgency.

(D4) In a case in which the object or the desire of the user cannot be achieved, the refrigerator 213 executes a notification representing an indication thereof. For example, in a case in which it is determined that the specified food ingredient is not present inside a room, the refrigerator 213 only pronounces “BB is not present” or “Sorry” without light emission or emits light using a specific color (for example, red).

(E1) In order to cause a user to focus on the refrigerator 213, the refrigerator 213 outputs a sound urging attention.

(E2) The refrigerator 213 executes light emission according to the acquired information. For example, by using the acquired person information, in a case in which it is determined that a person feels thirsty and in a case in which it is determined that a person has a fever, the refrigerator 213 uses different sounds.

(F1) The refrigerator 213 may include a proximity sensor and execute a notification (a notification using light or a notification using a sound) based on notification information in a case in which the proximity sensor detects a person.

(F2) The refrigerator 213 may have an individual authentication function and a proximity sensor and execute a notification based on the notification information in a case in which the proximity sensor detects a specific user.

(F3) The refrigerator 213 may have an individual authentication function and execute a notification that is different according to a user.

FIG. 20 is a schematic diagram illustrating one example of the notification information table according to this embodiment. As illustrated in the drawing, the notification information table includes columns of items including an on trigger, light emitting places PR-1, PR-2, . . . , PR-M, a sound, and an off trigger. Here, “on trigger” represents a trigger for starting a notification, and “off trigger” represents a trigger for ending the notification.

The notification information table is data in the form of a two-dimensional table formed by rows and columns in which notification information is stored for each on trigger. In this table, “-” (hyphen) represents absence of information. For example, in a case in which “-” is set in the item of the light emitting place PR-m, it represents that no emission is executed.

For example, notification information of the first row in FIG. 20 represents that the light emitting place PR-1 (for example, a light emitting unit L11) is caused to emit light in “pattern P21,” the light emitting place PR-2 (for example, a light emitting unit L14) is caused to emit light in “pattern P22), and a sound represented by “F-01” is pronounced in a case in which an indication of “being thirsty” is detected through speech. In addition, this notification information represents that light emission is ended in a case in which at least one of drinks inside a room of the refrigerator 213 is not detected.

For example, notification information of the second row illustrated in FIG. 20 represents that the light emitting place PR-1 (for example, the light emitting unit L11) is caused to emit light in “pattern P21” and the light emitting place PR-2 (for example, the light emitting unit L14) emits light in “pattern P23” in a case in which an abnormality in the vital data is detected. In other words, in the notification information of the first row and the notification information of the second row, on triggers are different, and there is a difference between the light emission patterns (patterns in the light emitting place PR-2).

In other words, in a case in which a trigger (on trigger) represented by the notification information table is different, the control unit M11 determines notification information in which at least one of patterns of light emitting places is different

### Fifth Embodiment

Hereinafter, a fifth embodiment of the present invention will be described in detail with reference to the drawings. In the fifth embodiment, another example of a use case of the control system 1 according to the first or second embodiment will be described.

In the fifth embodiment, a case in which a television set 215 is controlled using device information representing arrival of signals from the outside and person information will be described

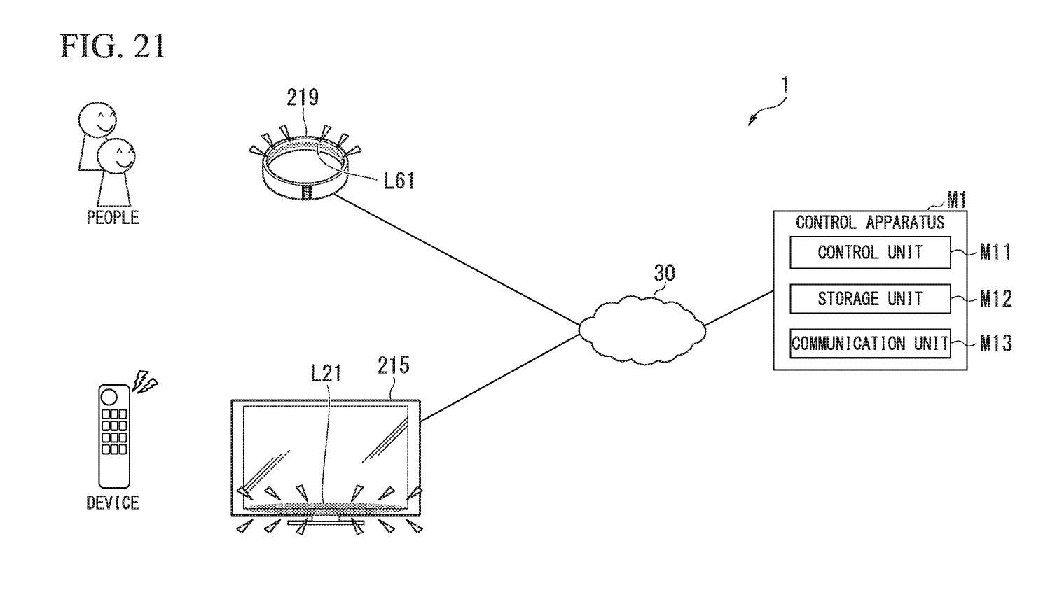

FIG. 21 is a functional block diagram illustrating a schematic configuration of the control system 1 according to the fifth embodiment of the present invention.

A control unit M11 acquires information representing detection of a person, individual authentication information or personal data (vital data or the like), and generated speech information as person information. For example, the control unit M11 acquires such information from a communication device 219 or the television set 215.

In addition, the control unit M11 acquires device information representing setting information or operation information. Here, the operation information may be information based on control using an external device of a target device U1-n.

The control unit M11 causes the refrigerator 213 to execute an operation or a notification by being triggered upon the next information. The control unit M11 uses acquired information for the trigger or the operation.

In a case in which an abnormality has occurred in vital data, the control unit M11 makes a contact to a contact point registered in advance (for example, a family doctor). For example, in a case in which a body temperature represented by person information acquired from the communication device 219 exceeds a threshold, in other words, in a case in which it is determined that a person has a fever, a contact is made to a contact point registered in advance. In this contact, the name of a user having a fever, the vital data, and a contact point of this user (for example, a telephone number of a television phone) are included. In addition, the control unit M11 stores history information representing detection of a high fever of the person in a storage unit M12.

A doctor executes an outgoing call requesting a television phone call for the television set 215 of the contact point of the user having a high fever. In such a case, the television set 215 transmits the presence of an incoming call and device information representing the origin of the call (doctor) to the control apparatus M1.

In a case in which it is detected that a person has a high fever, and there is an incoming television call in the television set 215, the control unit M11 determines operation information for executing an operation of turning on the power of the television set 215 and an operation of staring an application (browser) for the television phone.

The television set 215 starts to operate based on the operation information determined by the control unit M11 and receives the television call. In a case in which the television set 215 does not detect a person when a call is received by the television set 215, the control unit M11 may notify an indication representing that a person cannot receive the call to the origin of the call and start the operation of a recording device such as a hard disk recorder. The control unit M11 may record the contents of the television call in the operated recording device. In addition, in such a case, the control unit M11 may transmit the incoming call in the television set 215 to another device U1-n.

In a case in which it is detected that a person has a high fever, and there is an incoming television call in the television set 215, the control unit M11 causes the light emitting unit L21 of the television set 215 to emit light. Here, the control unit M11 represents high urgency using the light emitting form. In addition, in a case in which it is detected that a person has a high fever, and there is an incoming call from the doctor, the control unit M11 may execute light emission representing high urgency. In addition, the control unit M11 may direct devices U1-n capable of detecting persons among devices U1-n present in the house of a person having a fever to detect persons. Furthermore, the control unit M11 may generate notification information urging to watch the television set 215 for a device U1-n that has detected a person as a target device U1-n. In such a case, the target device U1-n executes a notification urging to watch the television set 215 based on the notification information.

The control unit M11 directs the television set 215 to execute a notification based on the determined notification information.

Hereinafter, a specific example of the notification will be illustrated.

(G1) After illuminating a lower part of the screen (light emitting unit L21), the television set 216 displays a video on the screen.

(G2) The television set 216 may generate a ringing tone.

### Sixth Embodiment

Hereinafter, a sixth embodiment of the present invention will be described in detail with reference to the drawings. In the sixth embodiment, another example of a use case of the control system 1 according to the first or second embodiment will be described.

In the sixth embodiment, a case in which a device U1-n supports cooking will be described.

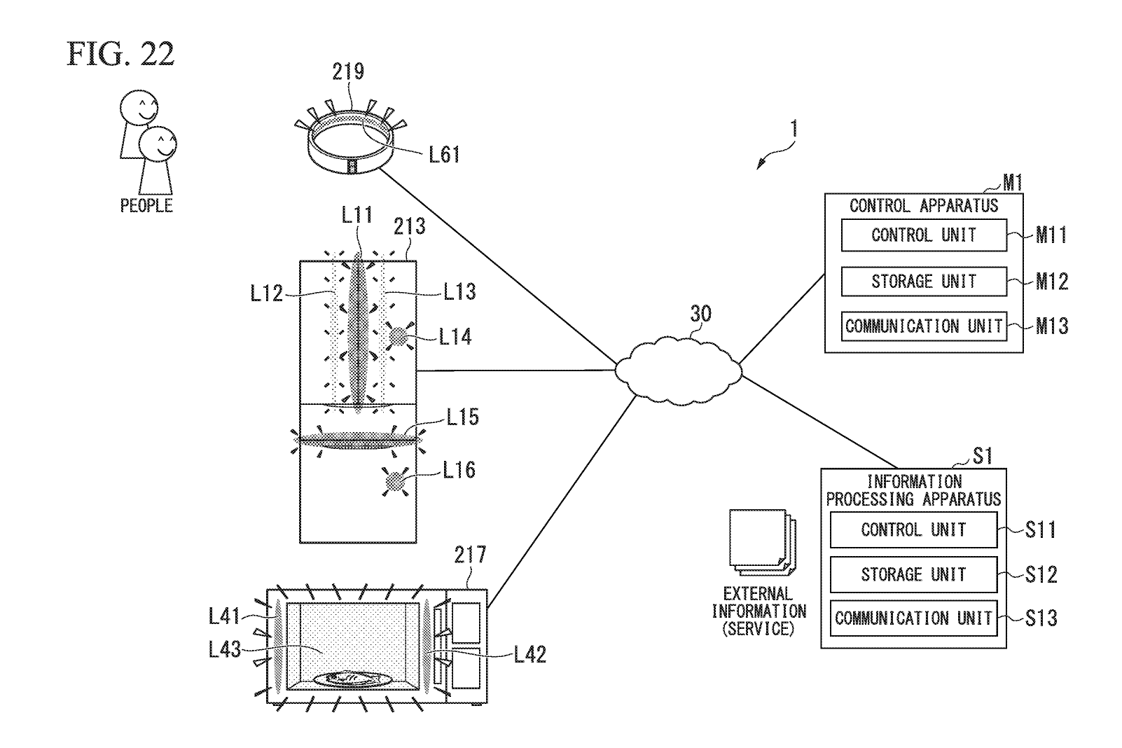

FIG. 22 is a functional block diagram illustrating a schematic configuration of the control system 1 according to the sixth embodiment of the present invention.

A control unit M11 acquires information representing detection of a person, individual authentication information or personal data, and generated speech information as person information. For example, the control unit M11 acquires such information from a communication device 219, a refrigerator 213, or a cooking device 217.

In addition, the control unit M11 acquires device information representing setting information, an operation status, or operation information.

Here, the operation information may be information based on control using an external device of a target device U1-n. In addition, the control unit M11 acquires external information from an information processing apparatus S1. For example, the external information is information representing a recipe of cooking.

The control unit M11, for example, causes the communication device 219, the refrigerator 213, and the cooking device 217 to execute an operation or a notification by being triggered upon a cooking direction. The control unit M11 uses acquired information for the trigger or the operation

For example, in a case in which generation of speech of “I want to cook vegetable gratin” is detected, the communication device 219 determines that there is a cooking direction from the user and transmits information representing the cooking direction to the control unit M11.

In addition, the control unit M11 may determine that there is a cooking direction by storing stock information of ingredients disposed in the refrigerator or the like, proposing the user to cook vegetable gratin based on the stock information, and detecting user's generation of speech representing an intention of agreement to this.

The control unit M11 determines operation information or notification information according to a cooking order based on device information representing the operation status of the device U1-n or device information representing an operation for the device U1-n and person information representing the generation of speech of the user.

In addition, the control unit M11 may transmit information representing a cooking status of the user (cooker) to another communication device 219, the communication devices 260 and 270, and an external device. For example, the control unit M11 transmits the information to mail address of family members of the cooker and specific members of a message service (for example, friends of the cooker). In addition, the control unit M11 may write the cooking status in an information posting service of a member organization.

The control unit M11 directs the communication device 219, the refrigerator 213, and the cooking device 217 based on the determined notification information to execute notifications. The communication device 219, the refrigerator 213, and the cooking device 217 execute notifications corresponding to operations relating to the cooking based on the notification information.

Hereinafter, a specific example of the notification will be illustrated.

(H1) The refrigerator 213 and the cooking device 217 executes light emission and pronunciation separately or synchronously.

(H2) The communication device 219 executes guidance of the cooking. For example, the communication device 219 notifies of an operation to be executed by the user next and an operation to be executed next for the device U1-n using pronunciation based on the speech information.

(H3) In a case in which a screen is included, the communication device 219 may display a guide such as a cooking order and a cooking method on the screen.

(H4) The communication device 219 may be placed near the user such as a portable device (communication devices 260 and 270) or a robot 211.

(H5) The communication device 219 may analyze person's speech to receive a speech input from the user.

(H6) The communication device 219 causes a part that is in contact with the skin of the wearer to emit light.

(H7) The communication device 219 changes light used for light emission in synchronization with the sound.

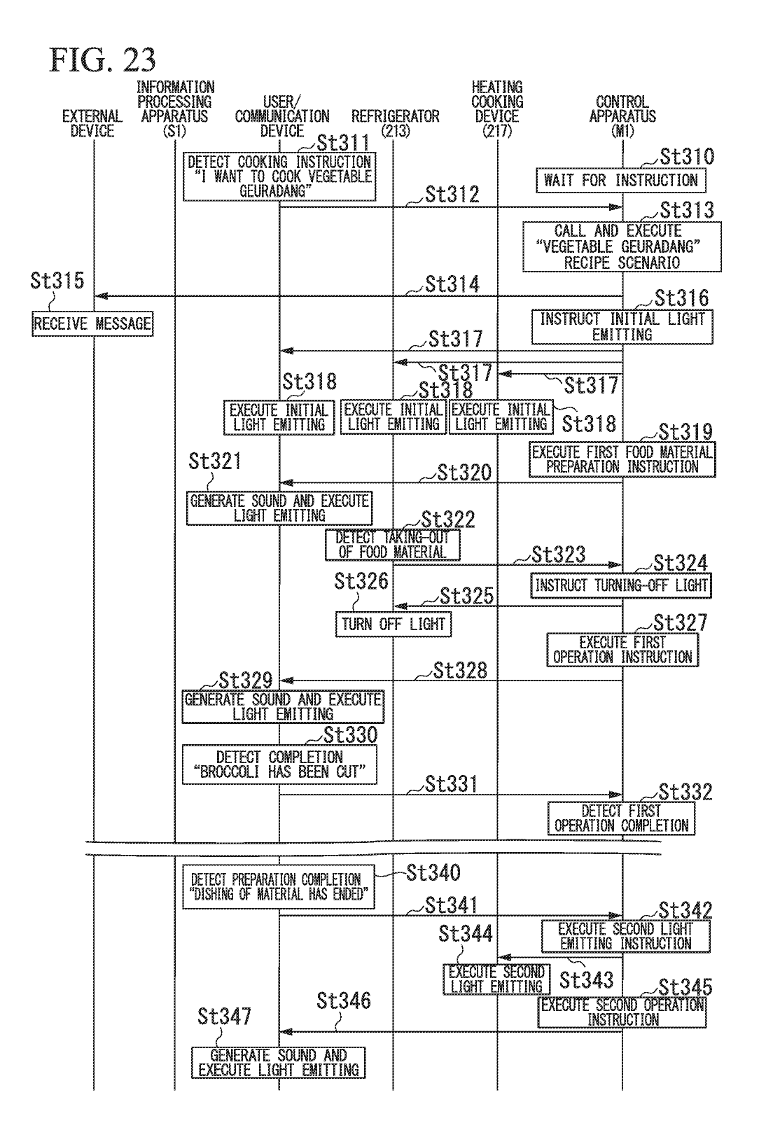

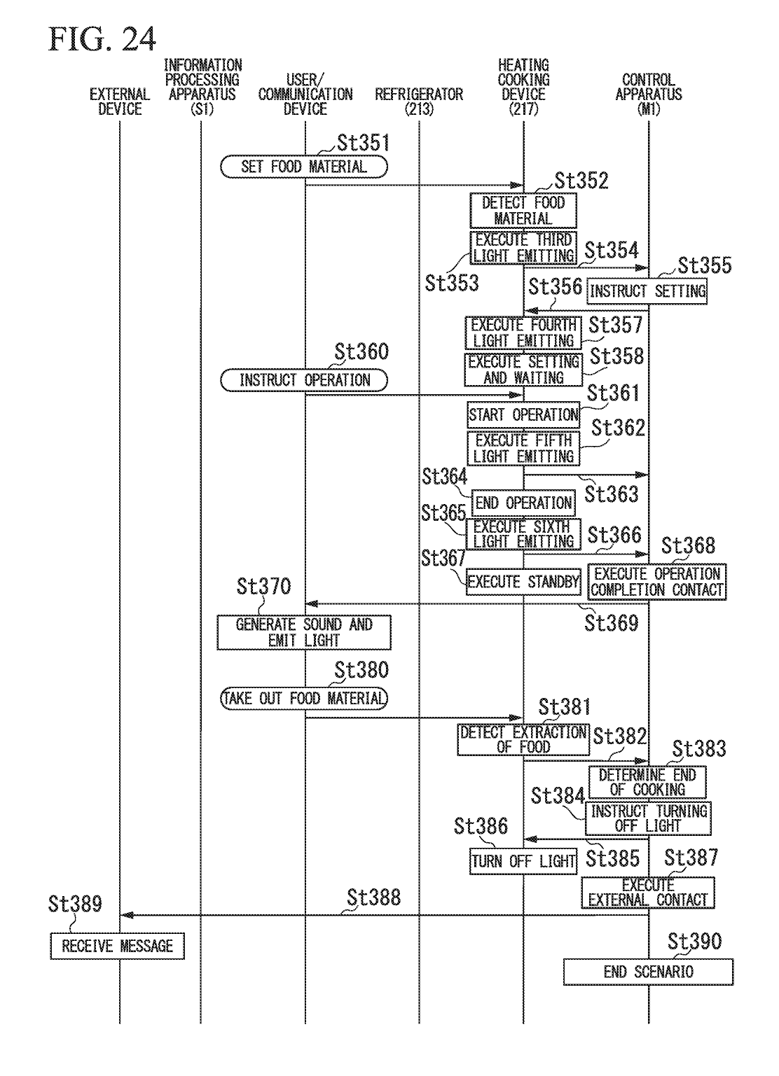

FIGS. 23 and 24 are schematic sequence diagrams of the control system according to this embodiment Tim sequence illustrated in FIG. 24 is continuation of the sequence illustrated in FIG. 23.

(Step St310) The control apparatus M1 is in a standby state waiting for a direction.

(Step St311) A user (for example, a child H3) generates speech of “I want to cook vegetable gratin.” Thereafter, the process proceeds to Step St312.

(Step St312) The communication device 219 (for example, the communication device 219-3) records the generation of the speech of Step St311 and transmits the recorded generated speech information to the control apparatus M1. In addition, in the generated speech information, person information representing the user identification information of a speech generator (a user using the communication device 219; in this example, the child H3) is included. Thereafter, the process proceeds to Step St313.

(Step St313) The control apparatus M1 analyzes the generated speech transmitted in Step St312 and determines that this generated speech is a cooking direction, and a food that is a cooking target is “vegetable gratin.” The cooking direction is not limited to speech but may be pressing of a button or an input of texts.

The control apparatus M1 stores a plurality of kinds of sequence information (also referred to as a “recipe scenario”) in which the cooking order is described among the sequence information. The control apparatus M1 selects a recipe scenario for a food (“vegetable gratin”) represented by cooking information included in the cooking order based on the cooking direction of Step St312. In addition, in this recipe scenario, the cooking order of “vegetable gratin” is described, and autonomous operation information (speech information describing a cooking method or a setting or a notification pattern of each device U1-n used for the cooking) is associated with each cooking order. The control apparatus M1 calls and executes the determined recipe scenario. In addition, the recipe scenario may be acquired from an external server such as the information processing apparatus S1. Furthermore, in the control apparatus M1, a correction value corresponding to the preference of a family can be stored or set, and, for example, adjustment of the recipe scenario such as a 30% decrease of salt or a 20% increase in the degree of burning may be executed. In addition, this correction value may be set for each of the family members and be adjusted for each of the family members. The control apparatus M1 or the device U1-n generates notification information (a message, light emission, or the like) in accordance with the adjustment and executes the setting of the device.

Thereafter, the process proceeds to Step St314.

(Step St314) The control apparatus M1 generates a message representing that the cooker (the child H3) has started cooking in accordance with the recipe scenario. In addition, in this message, a cooker, the start of cooking, names of devices U1-n to be used from now on (also referred to as a “used devices”), and the like may be included. The control apparatus M1 transmits the message generated in Step St314 to another communication device 219, the communication devices 260 and 270, or an external device (also referred to as “external device” in FIGS. 23 and 24). Here, a contact point is a destination set in advance and, for example, is a mail address of the mother H2 or the like. Thereafter, the process proceeds to Step St315.

(Step St315) The external device receives the message of Step St314. In this way, for example, even in a case in which the mother H2 is away from home or is not present in the kitchen, she can know the child H3's starting cooking at home, the child H3's use of used devices, and the like. Thereafter, the process proceeds to Step St316.

(Step St316) The control apparatus M1 generates notification information used for directing initial light emission in accordance with the recipe scenario. This notification information, for example, is information for causing all the used devices, in other words, all the target devices within the recipe scenario to execute notifications. In addition, in the notification information of the refrigerator 213, food ingredient information used for cooking a food represented by the cooking information is included

This notification information, for example, may cause a plurality of used devices to emit light simultaneously, sequentially, or alternately by synchronizing the used devices. In addition, this notification information may cause the same words (for example, “Lets cook vegetable gratin together!”) to be pronounced simultaneously or cause a series of words (“Today is vegetable gratin,” “Everybody ready?,” and “Great!”) to be pronounced sequentially or alternately. Thereafter, the process proceeds to Step St317.

(Step St317) The control apparatus M1 transmits notification information generated in Step St316 to the used devices, (the communication device 219, the refrigerator 213, and the cooking device 217). Thereafter, the process proceeds to Step St318.

(Step St318) The communication device 219, the refrigerator 213, and the cooking device 217 execute notifications (initial light emission) based on the notification information of Step St317. Here, in a case in which a food ingredient represented by the food ingredient information is present inside a room based on the food ingredient information included in the notification information, the refrigerator 213 illuminates the light emitting unit L11 (opening part), the light emitting units L14 and L16, and the like (parts representing places in which the food ingredients are placed). Meanwhile, the cooking device 217 illuminates the light emitting unit L41, L42, or L43 (door). In other words, the refrigerator 213 and the cooking device 217 may illuminate a part that brings the benefit to the user or a part that achieves the object or the desire of the user.

The communication device 219, the refrigerator 213, and the cooking device 217 are synchronized with each other based on the notification information and, for example, emit light simultaneously or alternately. In addition, the communication device 219, the refrigerator 213, and the cooking device 217 are synchronized with each other based on the notification information and pronounce the same words simultaneously or pronounce a series of words sequentially. Thereafter, the process proceeds to Step St319.

In addition, in the notification information, timing information (for example, time) representing a notification timing is included for each used device and each notification, and the used devices are synchronized with each other using the timing information.

(Step St319) The control apparatus M1 generates notification information for directing the preparation of a first food ingredient (for example, “broccoli”). This notification information includes speech information “Please prepare ingredients. They are inside the refrigerator.” Thereafter, the process proceeds to Step St320.

(Step St320) The control apparatus M1 transmits the notification information generated in Step St319 to the communication device 219. Thereafter, the process proceeds to Step St321.

(Step St321) The communication device 219 executes a notification (pronunciation or tight emission) based on the notification information transmitted in Step St320. Thereafter, the process proceeds to Step St322.

(Step St322) The refrigerator 213 detects that the food ingredient has been taken out. More specifically, the refrigerator 213 monitors food ingredients in the rooms by using sensors of a weight, an image, infrared rays, and the like or through a user operation and detects disappearance of a food ingredient. Alternatively, the refrigerator 213 may determine that a food ingredient has been taken out under a condition that the refrigerator 213 has been open after the notification of Step St321. In addition, this determination may be executed by the control apparatus M1. Thereafter, the process proceeds to Step St323.

(Step St323) The refrigerator 213 transmits information representing that the food ingredient has been taken out to the control apparatus M1. Thereafter, the process proceeds to Step St324.

(Step St324) The control apparatus M1 generates notification information for directing the refrigerator 213 to turn off the initial light emission of Step St318. Thereafter, the process proceeds to Step St325.

(Step St325) The control apparatus M1 transmits the notification information generated in Step St324 to the refrigerator 213. Thereafter, the process proceeds to Step St326 and Step St327.

(Step St326) The refrigerator 213 turns off the initial light emission of Step St318 based on the notification information transmitted in Step St325.

(Step St327) The control apparatus M1 generates notification information urging the user to execute a cooking operation (first operation) of the first food ingredient in accordance with the recipe scenario. This notification information includes speech information “Let's cut broccoli!” Thereafter, the process proceeds to Step St328.

(Step St328) The control apparatus M1 transmits the notification information generated in Step St327 to the communication device 219. Thereafter; the process proceeds to Step St329.

(Step St329) The communication device 219 executes a notification (pronunciation or light emission) based on the notification information transmitted in Step St328. In addition, in the notification information, notification information urging the user to mate a contact after the operation, for example, speech information “When broccoli is cut, please let me know!” may be included. In addition, the control apparatus M1 may generate notification information for checking the user whether or not the operation has been completed, for example, speech information “Has broccoli been cut?” hi such a case, for example, after the notification of Step St329, the communication device 219 may check the user of whether the operation has been completed at a time interval set in advance (for example, for every five minutes). Thereafter, the process proceeds to Step St330.

(Step St330) The user executes generation of speech “Broccoli has been cut!” Thereafter, the process proceeds to Step St331.

(Step St331) The communication device 219 records the generated speech of Step St330 and transmits the recorded generated speech information to the control apparatus M1. Thereafter, the process proceeds to Step St332.

(Step St332) The control apparatus M1 analyzes the generated speech transmitted in Step St312. The control apparatus M1 determines that information of completion (being cut) of the cooking operation (cutting) of the first food ingredient (broccoli) in the notification information of Step St327 is included in the generated speech. In this case, the control apparatus M1 determines that the cooking operation (first operation) of Step St327 has been completed. Thereafter, the control system 1 repeats urging a cooking operation of another food ingredient and determining the completion of the cooking operation.

(Step St340) The user generates speech “DISHING OF INGREDIENTS HAS ENDED.” Thereafter, the process proceeds to Step St341.

(Step St341) The communication device 219 records the generated speech of Step St341 and transmits the recorded generated speech information to the control apparatus M1. Thereafter, the process proceeds to Step St342.

(Step St342) The control apparatus M1 analysis the generated speech transmitted in Step St341. The control apparatus M1 determines that the operation of cutting the food ingredient and the dishing of the food ingredient have been completed based on the history information and the recipe scenario. In this case, the control apparatus M1 determines that the food ingredients are ready to be heated. In addition, the control apparatus M1 may determine that the food ingredients are ready to be heated based on not only speech but also pressing of a button or an input of texts.

The control apparatus M1 generates notification information for directing second light emission in accordance with the recipe scenario.

This second light emission, for example, represents that cooking is executed next using the cooking device 217. Thereafter, the process proceeds to Step St343.

(Step St343) The control apparatus M1 transmits the notification information generated in Step St342 to the cooking device 217. Thereafter, the process proceeds to Step St344 and Step St345.

(Step St344) The cooking device 217 executes a notification (second light emission) based on the notification information transmitted in Step St343. Thereafter, the cooking device 217 waits for the setting of food ingredients inside a room.

(Step St345) The control apparatus M1 generates notification information for urging the user to execute a cooking operation (second operation) of heating the dished food ingredients using the cooking device 217 in accordance with the recipe scenario. This notification information includes speech information “PLEASE SET FOOD INGREDIENTS IN ELECTRONIC RANGE!”

Thereafter, the process proceeds to Step St346.

(Step St346) The control apparatus M1 transmits the notification information generated in Step St345 to the communication device 219. Thereafter, the process proceeds to Step St347.

(Step St347) The communication device 219 executes a notification (pronunciation or light emission) based on the notification information transmitted in Step St346. Thereafter, the process proceeds to Step St351 illustrated in FIG. 24.

(Step St351) The user sets the dished food ingredients in the cooking device 217. Thereafter, the process proceeds to Step St352.

(Step St352) The cooking device 217 detects that the food ingredients have been set inside a room. Thereafter, the process proceeds to Step St353.

(Step St353) The cooking device 217 executes a notification (third light emission) representing the detection of the setting of the food ingredients inside the room. Thereafter, the process proceeds to Step St354.

(Step St354) The cooking device 217 transmits information representing that food ingredients are set inside the room to the control apparatus M1. Thereafter, the process proceeds to Step St355.

(Step St355) The control apparatus M1 generates autonomous operation information used for directing the setting of the cooking device 217 in accordance with the recipe scenario. This setting is a setting (for example, an “oven” mode, a set temperature of “250” degrees, and a set time of “15” minutes) of a case in which the food ingredients (dished food ingredients) set inside the room of the cooking device 217 are cooked. In addition, in this autonomous operation information, notification information representing fourth light emission is included. This fourth light emission represents a function exerted by the cooking device 217 as a result of the setting. For example, the fourth light emission is displaying of an image in which a fire or a frame appears in the light emitting unit L43 of the cooking device 217. Thereafter, the process proceeds to Step St356.

(Step St356) The control apparatus M1 transmits autonomous operation information generated in Step St355 to the cooking device 217. Thereafter, the process proceeds to Step St357.

(Step St357) The cooking device 217 executes a notification (fourth light emission) based on tire autonomous operation information transmitted in Step St356. Thereafter, the process proceeds to Step St358.

(Step St358) The cooking device 217 executes setting based on the autonomous operation information transmitted in Step St356. Thereafter, the cooking device 217 waits for an operation start direction. Thereafter, the process proceeds to Step St360.

(Step St360) The user executes an operation direction for the cooking device 217. More specifically, the user presses a start button of the cooking device 217. Thereafter, the process proceeds to Step St361.

(Step St361) The cooking device 217 starts an operation of setting executed in Step St358. In addition, in a case in which the user executes another setting, the cooking device 217 starts an operation of the setting executed by the user. Thereafter, the process proceeds to Step St362.

(Step St362) The cooking device 217 executes a notification (fifth light emission) representing that the operation of the setting executed in Step St358 is executed. In other words, the fifth light emission represents being in the middle of operation, and an image different from that of the fourth light emission, for example, is displayed such that a fire or a flame rotates in the light emitting unit L43 of the cooking device 217. Thereafter, the process proceeds to Step St363.

(Step St363) The cooking device 217 transmits information representing the start of the operation to the control apparatus M1. Thereafter, the process proceeds to Step St364.

(Step St364) The cooking device 217 completes the operation started in Step St361. In addition, the cooking device 217 completes the operation in a case in which the user opens the door of the cooking device 217, a case in which the cooking device 217 detects the completion of the operation, a case in which the set time has elapsed, or the like.

Thereafter, the process proceeds to Step St365.

(Step St365) The cooking device 217 executes a notification (sixth light emission) representing the completion of the operation. In other words, the sixth light emission, for example, is displaying of an image different from those of both the fourth light emission and the fifth light emission. Thereafter, the process proceeds to Step St366.

(Step St366) The cooking device 217 transmits information representing the completion of the operation started in Step St361 to the control apparatus M1. Thereafter, the process proceeds to Steps St367 and St368.

(Step St367) The cooking device 217 waits for the food ingredients inside the room to be taken out

(Step St368) The control apparatus M1 generates notification information representing the completion of the operation started in Step St361 in accordance with the recipe scenario. Thereafter, the process proceeds to Step St369.

(Step St369) The control apparatus M1 transmits the notification information generated in Step St368 to the communication device 219. Thereafter, the process proceeds to Step St370.

(Step St370) The communication device 219 executes a notification (pronunciation and light emission) based on the notification information transmitted in Step St369. Thereafter, the process proceeds to Step St380.

In addition, the communication device 219 may receive notification information from the cooking device 217 and execute a notification. In such a case, the cooking device 217 generates notification information representing the completion of the operation started in Step St361 instead of Step St366 and transmits the generated notification information to the communication device 219.

(Step St380) The user takes out the food ingredients (heated food “vegetable gratin”) disposed inside the room of the heating cooling device 217 into the cooking device 217. Thereafter, the process proceeds to Step St381.

(Step St381) The cooking device 217 detects that the food ingredients disposed inside the room have been taken out. Thereafter, the process proceeds to Step St382.

(Step St382) The cooking device 217 transmits information representing that the food ingredients disposed inside the room have been taken out to the control apparatus M1. Thereafter, the process proceeds to Step St383.

(Step St383) The control apparatus M1 determines that the cooking using die cooking device 217 has been completed. Thereafter, the process proceeds to Step St384.

(Step St384) The control apparatus M1 generates notification information directing to turn off the sixth light emission of Step St365 in accordance with the recipe scenario. Thereafter, the process proceeds to Step St385.

(Step St385) The control apparatus M1 transmits the notification information generated in Step St384 to the cooking device 217. Thereafter, the process proceeds to Step St386 and Step St387.

(Step St386) The cooking device 217 turns off the sixth light emission of Step St365 based on the notification information transmitted in Step St385. In addition, the cooking device 217 may be automatically burned off after St381.

(Step St387) The control apparatus M1 generates a message representing that the cooker (the child H3) has ended the cooking in accordance with the recipe scenario. In addition, in this message, the cooker, the end of the cooking, and the like may be included. Thereafter, the process proceeds to Step St388.

(Step St388) The control apparatus M1 transmits the message generated in Step St387 to an external device. Here, a contact point is a destination set in advance and, for example, is a mail address of the mother H2 or the like. Thereafter, the process proceeds to Step St389.

(Step St389) The external device receives the message of Step St388. Accordingly, for example, the mother H2 can know that the cooking has been ended without any problem. In other words, the control system 1 can deliver “relief.” Thereafter, the process proceeds to Step St390.

(Step St390) The control apparatus M1 determines that the entire recipe scenario has been ended.

In addition, in each embodiment described above, a case in which the control apparatus M1 executes management using a room as the reference as a place in which each device U1-n is present has been described (FIG. 14). Instead of or in addition to this room, the inside of a car may be used. In other words, for example, autonomous operation information or notification information may be transmitted based on the device U1-n being present inside a specific car (a car in which the user is riding).

In addition, the control apparatus M1 may execute management using a house, a building, or the like as the reference and may execute management based on positional information that is finer than that of the room. In such a case, the control apparatus M1 may determine a target device (a device U1-n executing an operation) in relation with a relative position with respect to the device U1-n that has executed detection.

In addition, a part of each of the device U1-n, the control apparatus M1, and the information processing apparatus S1 according to the embodiment described above may be included in another device or apparatus. For example, the control unit M11, the storage unit M12, and the communication unit M13 of the control apparatus M1 may be included in the device U1-n. In addition, the units of the device U1-n and the control apparatus M1 may synchronize programs and data regularly or irregularly.

In addition, a part of each of the device U1-n, the control apparatus M1, and the information processing apparatus S1 may be realized by a computer. In such a case, by recording a program used for realizing this control function on a computer-readable recording medium and causing a computer system to read and execute the program recorded on this recording medium, the control function may be realized. The “computer system” described here is a computer system built in each of the device U1-n, the control apparatus M1, and the information processing apparatus S1 and includes an OS and hardware such as peripherals. Furthermore, the “computer-readable recording medium” represents a portable medium such as a flexible disc, a magneto-optical disk, a ROM, or a CD-ROM or a storage device such as a hard disk built in the computer system. In addition, the “computer-readable recording medium” includes a medium that dynamically maintains a program for a short time such as a communication line of a case in which a program is transmitted through a network such as the Internet or a communication circuit line such a telephone circuit line and a medium that maintains a program for a predetermined time such as a volatile memory of the inside of a computer system serving as a server or a client in such a case. Furthermore, the program described above may be a program used for realizing a part of the function described above or a program to be combined with a program that has already been recorded in die computer system for realizing the function described above.

In addition, a part or the whole of each of the device U1-n, the control apparatus M1, and the information processing apparatus S1 according to the embodiment described may be realized using an integrated circuit of a large scale integration (LSI) or the like. Each functional block of each of the device U1-n, the control apparatus M1, and the information processing apparatus S1 may be individually configured as a processor, or a part or all the functional blocks may be integrated and configured as a processor. In addition, a technique used for configuring the integrated circuit is not limited to the LSI, and each function may be realized by a dedicated circuit or a general-purpose processor. Furthermore, in a case in which a technology of configuring an integrated circuit replacing the LSI emerges in accordance with the progress of semiconductor technologies, an integrated circuit using such a technology may be used.

As above, while one embodiment of the present invention has been described in detail with reference to the drawings, a specific configuration is not limited to that described above, and various design changes and the like may be made in a range not departing from the concept of the present invention.

### INDUSTRIAL APPLICABILITY

Several aspects of the present invention can be applied to a control system, an operation determining apparatus, a device, a control method, a control program, and the like that are necessary to cause a device and the like such as electrical appliances to have emotions for a user to arouse user's sympathies for the device and the like.

### DESCRIPTION OF REFERENCE SYMBOLS

1 . . . Control system
210 and 220 . . . House
230 . . . Medical institution server
240 . . . Local government server
250 . . . Business server
219, 219-1, 219-2, 219-3, 229, 260, and 270 . . . Communication device
280 . . . Car
30 . . . Internet
211 and 221 . . . Robot
222 . . . Router
213 and 223 . . . Refrigerator
214 and 224 . . . Lighting device
215 and 225 . . . Television set
216 and 226 . . . Air conditioner
217 . . . Cooking device
218 . . . Air purifier
227 . . . Vacuum cleaner
228 . . . Smart mirror
U1-n . . . Device
S1 . . . Information processing apparatus
M1 . . . Control apparatus
U11-n . . . Sensor unit
U12-n . . . Operation unit
U13-n . . . Input/output unit
U14-n . . . Control unit
U15-n . . . Storage unit
U16-n . . . Communication unit
S11 . . . Control unit
S12 . . . Storage unit
S13 . . . Communication unit
M11 . . . Control unit
M12 . . . Storage unit
M13 . . . Communication unit
L11 to L16, L21, L31, L41 to L43, L51, L61, 71, and L72 . . . Light emitting unit
U111-n . . . Operation control sensor unit
U112-n . . . Environment detection sensor unit
U131-n . . . Input unit
U132-n . . . Display unit
U132-n . . . Light emitting unit
U133-n . . . Sound output unit
U141-n . . . Overall control unit
U142-n . . . Operation control unit
U143-n . . . Output control unit
U151-n . . . Device control information storing unit
U152-n . . . Information storing unit and registration information storing unit
U153-n, S111 . . . Service information acquiring unit
S112 . . . Information correspondence unit
S121 . . . Acquisition destination information storing unit
S122 . . . Correspondence information storing unit
S123 . . . Acquisition history storing unit
M111 . . . Information acquiring unit
M112 . . . Analysis unit
M113 . . . Output determining unit
M114 . . . Sequence control unit
M115 . . . Sequence updating unit
M121 . . . Information storing unit
M122 . . . Sequence storing unit
M123 . . . Notification information storing unit
M124 . . . History storing unit

1. A control system comprising:
a storage unit that stores correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other;
an information acquiring unit that acquires the at least two pieces of information;
a determination unit that determines the autonomous operation information based on the correspondence information and the at least two pieces of information acquired by the information acquiring unit; and
an output unit that executes a notification, which is a notification corresponding to an operation based on the operation information, using a sound, a light, or an image in accordance with the notification information based on the autonomous operation information determined by the determination unit.

2. The control system according to claim 1,
wherein the autonomous operation information further includes identification information of the plurality of devices,
wherein the determination unit determines one piece of the identification information of the plurality of devices based on the correspondence information and the at least two pieces of information acquired by the information acquiring unit, and
wherein a device represented by the one piece of the identification information of the plurality of devices determined by the determination unit includes the output unit, and the output unit executes the notification.

3. The control system according to claim 2,
wherein the storage unit stores the at least two pieces of information and the identification information of the plurality of devices in association with each other as the correspondence information,
wherein the determination unit determines a plurality of pieces of the identification information of the plurality of devices based on the correspondence information and the at least two pieces of information acquired by the information acquiring unit, and
wherein a plurality of devices represented by the plurality of pieces of the identification information of the plurality of devices determined by the determination unit include the output units, and the output units execute different notifications.

4. The control system according to claim 1, the control system further comprising:
a direction input unit that inputs a direction from a user; and
an update unit that updates the correspondence information based on the direction input to the direction input unit after the output unit executes the notification.

5. The control system according to claim 1, the control system further comprising:
a communication unit that transmits the correspondence information for a target device to the target device executing an operation,
wherein the target device includes the determination unit, and
wherein the determination unit determines the autonomous operation information based on the correspondence information transmitted by the communication unit and the at least two pieces of information acquired by the information acquiring unit.

6. An operation determining apparatus comprising:
an information acquiring unit that reads correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other from a storage unit and acquires the at least two pieces of information; and
a determination unit that determines the autonomous operation information based on the correspondence information and the at least two pieces of information acquired by the information acquiring unit.

7. A device comprising:
an operation unit that exerts a function of its own device;
a direction input unit that inputs a direction from a user;
a communication unit that receives autonomous operation information, which is autonomous operation information based on environment information, person information, or device information detected by another device, including notification information corresponding to an operation of its own device; and
an output unit that executes a notification, which is a notification corresponding to the operation of its own device, using a sound, a light, or an image in accordance with the notification information based on the autonomous operation information.

8. The device according to claim 7, wherein the communication unit transmits environment information, person information, or device information detected by its own device.

9. A control method comprising:
reading correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other from a storage unit and acquiring the at least two pieces of information using an information acquiring unit;
determining the autonomous operation information based on the correspondence information and the at least two pieces of information acquired using a determination unit; and
executing a notification, which is a notification corresponding to an operation based on the operation information, using a sound, a light, or an image in accordance with the notification information based on the autonomous operation information determined using an output unit.

10. A non-transitory computer-readable recording medium in which a computer program is stored, the control program causing a computer of one or a plurality of apparatuses included in a control system to execute:
reading correspondence information in which at least two pieces of information among environment information, person information, and the device information detected by at least one of a plurality of devices and external information provided by an external device and autonomous operation information including operation information of the plurality of devices and notification information representing notification using a sound, a light, or an image of the plurality of devices are associated with each other from a storage unit and acquiring the at least two pieces of information;
determining the autonomous operation information based on the correspondence information and the at least two pieces of information acquired; and
executing a notification, which is a notification corresponding to an operation based on the operation information, using a sound, a light, or an image in accordance with the notification information based on the autonomous operation information determined.
